(19) United States
(12) Patent Application Publication
(10) Pub. No.: US 2026/0314903 A1
(43) Pub. Date: Oct. 15, 2026

(54) Multipurpose Ergonomic And Therapeutic Dustpan

(71) Applicant: Erik Barnaal, Glendale, CO (US)

(72) Inventor: Erik Barnaal, Glendale, CO (US)

(21) Appl. No.: 18/838,237

(22) PCT Filed: Feb. 14, 2023
(86) PCT No.: PCT/US2023/013066

§ 371 Date: Aug. 14, 2024

(51) Int. Cl. A47L 13/52; B62B 1/24

(52) U.S. Cl. CPC A47L 13/52; B62B 1/24; B62B 2202/50

(57) ABSTRACT

A multipurpose ergonomic and therapeutic dustpan is described. In an embodiment, the device has two handles (120, 130) extending at different positions along a stem (110). The handles (120, 130) can be used for different modes of operation or together to provide leverage and therapy advantages. Some embodiments include one or more blades (140, 142) attached to the stem (110), each blade being wider than the stem (110). Leverage advantage can also be gained by utilizing the handles (130, 120) and one of one or more blades (140, 142) in unison. Other embodiments also include a wheel or wheels (182) attached to a ground item container (172).

### CROSS-REFERENCE TO RELATED APPLICATIONS

This application claims the benefit of U.S. Provisional Patent Application Ser. No. 63/310,094, filed on Feb. 14, 2022, and priority to International Application No. PCT/US2023/013066, filed on Feb. 14, 2023, under the Patent Cooperation Treaty (PCT).

### BACKGROUND

The invention relates to lobby dustpans which are used to pick up debris while sweeping. Although a flat piece of bark was presumably used alongside the first branch brooms, the first patented dustpan in the United States was invented by T. E. McNeill, an American inventor. Mcneill's invention, US20811A granted Jul. 6, 1858, added a short wooden handle to the device and revealed the bump that helps hold debris in the pan. Lloyd P. Ray, a former slave, made significant improvements to the dustpan. He disclosed a short wooden pole vertically connected to a collection pan made of metal in U.S. Pat. No. 587,607A which was granted Aug. 3, 1897. This allowed a user to operate the dustpan in conjunction with a broom, without bending over, for the first time in recorded human history.

U.S. Pat. No. 1,203,697A was awarded to Alvah J Bump on Nov. 7, 1916. Ironically, Bump unveiled an improvement to McNeill's bump, a hinged dustpan that rotates about a horizontal axis when lifted. The advantages include a more secure way of holding the contents when carrying, confined contents and easier storage. Contempory casual observation of restaurants and grocery stores proves the validity of this arrangement. There are disadvantages when McNeill's bump plus the force of gravity are sufficient to hold contents. Another example of a disadvantage is when confined contents and/or storage are not issues. Simply, the operation of the hinge can be awkward, time consuming and oblige additional energy.

Patent U.S. Pat. No. 5,594,975A, granted Jan. 21, 1997, to White Mop Wringer Company discloses a vertically adjustable horizontal handle. It is described to cater to a users height and preference for various modes of operation. As an example of the modes, the user is taught sweeping across the front of the body, or toward the body. These options offer the user an improved user experience. However, frequent adjustment could be time consuming, annoying or even an ergonomic disadvantage.

There is a large mechanical disadvantage for both arms when using a lobby broom and dustpan. This is because the effort arm is the width of the wrist when compared to the distance to the ground of the load arm, Mechanical Advantage=(Effort Arm Distance)/(Load arm Distance). Smaller hand, wrist and forearm muscles are not suited to withstand these forces without discomfort, pain and possible injury. The degree of strain and injury depends on variables such as strength of muscles and time spent. Generally, one of the most common tasks preformed by humans has been inhernetly injurious since Ray added the waist high pole which decreased mechanical advantage by an order of magnitude.

Recently, various catch-all tool handle designs incorporating a lower horizontal handle and upper forearm enclosure have been disclosed for hand held implements, including dustpans. This general design can extend the effort arm distance considerably when compared to the width of the wrist, therefore offering the user a leverage advantage over single handle operation when lifting. Granted Jul. 29, 2003, U.S. Pat. No. 6,598,266B1, to Elliott teaches a lower horizontal handle with an upper forearm strap. A Japanese Patent Application JP2014519414A, published Aug. 14, 2014, imparts a lower horizontal handle with a rotatable upper arm ring. U.S. Pat. No. 7,637,882B2, granted Dec. 29, 2009, assigned to Advance Handle Co LLC shows a lower angled handle and a 360 degree helix enclosure.

### SUMMARY

While using a broom essentially has one mode of operation, a stand-up dustpan has different tasks a user demands of it. The simple short handle invented by Ray is still the most common design used today and a user can use this simple handle for the various tasks. However, the combination of an uncomfortable vertical flexed hand position and severe mechanical disadvantages are an ergonmic disaster for an average user.

My invention, a Multipurpose Ergonomic and Therapeutic Lobby Dustpan, is designed to offer a user easily accessable advantage for different modes of use while offering therapeutic benefit. The user typically uses a lobby dustpan not only while sweeping, but will also carry it above the ground when moving. When the user arrives at a destination to deposit the contents of dustpan, the user must lift the device to breach the edge of a container. Finally, the user must turn the pan to empty or dump the contents into the container.

There is one common issue with the across-the-board tool handle designs. They do not consider the details of operation of all the specific tools they could “theoretically” be put on. Different tools that have different tool ends for different jobs can likely require different operational strategies. There are many specific duties demanded of a lobby dustpan.

The scope of operation of a shovel, broom or crutch is different from the scope of operation of a lobby dustpan. Any of the disclosed lower horizontal handle with an enclosed upper forearm support lobby dustpan devices have clear disadvantages that render them useless in real world applications. For example, the White Mop Wringer Company recognized that a user will place a dustpan at different locations on the ground in relation to the body when sweeping. The reasons for which vary from user preference to strategic reasons for collecting various ground items.

Because the arm angles away from the body to grasp the handle, the enclosed forearm support must also reflect the same angle in relation to the axis of a dustpan connecting pole when standing normally. Typical operation of a lobby dustpan requires different locations of the dustpan such as at the side or front of the body. The different locations require different angles between the arm and z axis of the dustpan.

Doubly, any rotation of the ground item container at any of the locations, alters this angle further. By design, any enclosed forearm apparatus with the lower horizontal handle restricts movement of the forearm when the handle is grasped. In order to lay the dustpan flat on the ground, the user has to compensate with awkward body positions or not change positions from the original adjustment.

Because of the variety of user sizes, another disadvantage of arm enclosure devices in general are fitment challenges. While this demand may be worthwhile for some users, there is no practible design that accomodates a large variety of users. There are also engagement issues that can be construed as a disadvantage. This is because a user must thread their hand and forearm into the device, then possibly adjust it. This strategy is awkward, may require adept cordination and most likely requires help from a second arm.

The time it takes to engage such devices is also a concern. Doubly, it also takes time to disengage these devices along with the reverse of the engagement issues. Real world applications can require a user to disengage these devices constantly to for example . . . address larger items, tend a trash can or answer a cell phone. Leverage can be gained by connecting the hand to the forearm. However, a lobby dustpan user demands a unique set of duties or modes of operation unsimilar to the other kinds of devices listed in these disclosures.

An embodiment of the Multipurpose Ergonomic Dustpan has two horizontal handles, the top handle adjusted to the height a user might find comfortable while sweeping, with a relaxed arm. The lower handle, similarly postitioned below the top handle, makes it possible to carry the Multipurpose Ergonomic Dustpan with a relaxed arm, which is an ergonomic benefit. When the user grasps the bottom handle to carry the device, the top handle gently presses into the inside of the wrist providing leverage advantage for stability while offering a pressure point therapuetic benefit.

When the user lifts an embodiment of the Multipurpose Ergonomic Dustpan, it can be rotated such that the lower handle partially becomes the fulcrum of a lever system to offer the user Mechanical Advantage while at the same time increasing the therapuetic benefit. When the user dumps the contents of the dustpan, the lower handle fully becomes a component of the lever system and the therapuetic benefit is briefly maximized. Therefore, the single upper handle serves different duties across the operational modes. Besides therapy, it is also used while sweeping, and a component of a useful lever system for carrying, lifting and dumping. The lower handle, used while carying, lifting and dumping, also serves different duties.

Another embodient offers the user a blade or paddle above the handles to brace the forearm while lifting larger loads with a handle. This creates a sizable effort arm in a lever system that equips the user with a significant Mechanical Advantage, an ergonomic benefit. Dual offset forearm fitments on the paddle or paddles engage either forearm at a natural postion when lifiting. A knob located at the end of the handle provides the grip a brace as the user lifts. Using the knob allows a relaxed grip because the force from the lever system is transferred to the bone structure of the hand.

After lifting, when the user turns the pan to shift to dumping mode, the fulcrum of the lever system is seamlessly transferred from the forearm of the user to the top handle contact point of the wrist. This synergy is not only convenient, but an ergonomic aid. Also a new kind of ground item collection that leaves out the sweeping device is shown, including a time and energy efficient way to gather items without breaking stride. A new stategy for keeping contents in the collection pan across the modes is also availed to the user.

Yet another embodiment incorporates a third horizontal handle and dustpan with a wheel/s. This improvement allows the user to transport the Multipurpose Ergonomic Dustpan without the need to lift then carry the device, offering the user energy savings and ergonomic benefits. Further embodiments include a hole embedded in the top of the paddle that creates an alternate handle that can be grasped at two alternate wrist angles, an ergonomic advantage. This embodiment can also include the wheel/s and the user can use the hole handle when transporting the device. Other embodiments incorporate the handle apparatus as the top portion of a telescoping pole for user adjustment. Other embodiments utilize a telescoping pole to connect the handle apparatus to the dustpan.

### BRIEF DESCRIPTION OF DRAWINGS

FIG. 1 is an isometric front view of an example of a handle apparatus suitable for use with a Multipurpose Ergonomic Dustpan in accordance with an embodiment;

FIG. 2 is a cross-sectional side view of the handle apparatus of FIG. 1;

FIG. 3 is an isometric front view of an example of an alternate handle apparatus suitable for use with a Multipurpose Ergonomic Dustpan in accordance with another embodiment;

FIG. 4 is a front plan view of the handle apparatus of FIG. 3;

FIG. 5 is a top plan view of the handle apparatus of FIG. 3;

FIG. 6 is an isometric front view of an example of a further alternate handle apparatus suitable for use with a Multipurpose Ergonomic Dustpan in accordance with another embodiment;

FIG. 7 is an isometric front view of an example of a further alternate handle suitable for use with a Multipurpose Ergonomic Dustpan in accordance with another embodiment;

FIG. 8 is an isometric front view of an example of a further alternate handle suitable for use with a Multipurpose Ergonomic Dustpan in accordance with another embodiment;

FIG. 9 is an exploded isometric rear view of an example of a ground item container for use with a Multipurpose Ergonomic Dustpan in accordance with another embodiment;

FIG. 10 is an isometric front view of an example of a Multipurpose Ergonomic Dustpan in accordance with an embodiment;

FIG. 11 is a front view diagram of a user holding an example of a Multipurpose Ergonomic Dustpan in accordance with another embodiment;

FIG. 12 is a side view diagram of the user carrying an example of a Multipurpose Ergonomic Dustpan in accordance with another embodiment;

FIG. 13 is a side view diagram of the user lifting an example of the Multipurpose Ergonomic Dustpan in accordance with another embodiment;

FIG. 14 is an isometric front view diagram the user dumping the Multipurpose Ergonomic Dustpan of FIG. 13;

FIG. 15 is a side view diagram of the user pushing an example of a Multipurpose Ergonomic Dustpan in accordance with another embodiment;

FIG. 16 is a side view force vector diagram of a lifted conventional lobby dustpan;

FIG. 17 is a side view force vector diagram of the lifted Multipurpose Ergonomic Dustpan of FIG. 13;

FIG. 18 is a close up side view diagram of the user lifting the Multipurpose Ergonomic Dustpan of FIG. 13;

FIG. 19 is a close up isometric front view diagram of the user lifting and turning the Multipurpose Ergonomic Dustpan of FIG. 13;

FIG. 20 is a close up front view diagram of the user dumping the Multipurpose Ergonomic Dustpan of FIG. 13;

FIG. 21 is a front view force vector diagram of the user lifting and turning the conventional lobby dustpan of FIG. 16; and

FIG. 22 is a front view force vector diagram of the user lifting and turning the Multipurpose Ergonomic Dustpan of FIG. 13.

### DRAWINGS—REFERENCE NUMERALS

Double Horizontal Handle Apparatus 50 | Double Horizontal Handle with Forearm Supports Apparatus 52 | Triple Horizontal Handle with Forearm Supports Apparatus 54 | Double Horizontal Handle with Embedded Handle in Forearm Supports Apparatus 56 | Double Horizontal Handle with Back Paddle Apparatus 58 | Double Horizontal Handle with Forearm Supports Telescoping Spring Button Apparatus 60 | Double Horizontal Handle with Forearm Supports Telescoping Apparatus 62 | Spring Button Telescoping Double Handle with Forearm Supports Ergonomic and Therapeutic Lobby Dustpan 80 | Lever Clamp Telescoping Horizontal Handles with Forearm Supports Ergonomic and Therapeutic Lobby Dustpan 82 | Double Horizontal Handle Ergonomic and Therapeutic Lobby Dustpan 84 | Double Horizontal Handle with Forearm Supports Ergonomic and Therapeutic Lobby Dustpan 86 | Wheeled Triple Horizontal Handle with Forearm Supports Ergonomic and Therapeutic Lobby Dustpan 88 | Conventional Horizontal Handle Long Handle Dustpan 90 | Ground Target 102 | Handle Stem 110 | Pole Reciever Hole 112 | Upper Handle Stem 114 | Lower Handle Stem 116 | Telescoping Pole Reciever 118 | Sweep Handle 120 | Sweep Handle Grip Retention Knob 122 | Carry Handle 130 | Carry Handle Grip Retention Knob 132 | Handle to Dustpan Connecting Pole 126 | Left Forearm Support Paddle 140 | Right Forearm Support Paddle 142 | Left Forearm Ergonomic Contour 146 | Right Forearm Ergonomic Contour 148 | Dolly Handle 150 | Dolly Handle Grip Retention Knob 152 | Top Paddle 160 | Paddle Grip Opening 162 | Top Handle Grip 164 | Wheeled Ground Item Container 170 | Ground Item Container 172 | Ground Item Container Pole Reciever 174 | Ground Item Container Axle Housing 176 | Ground Item Container Axle Housing Axle Holes 178 | Ground Item Container Axle 180 | Ground Item Container Wheel 182 | Ground Item Container Axle Washer 184 | Ground Item Container Axle Nut 186 | Lever Action Tube Squeeze Clamp 188 | Handle Stem Spring Button Receiving Holes 190 | Outward Protruding Button Spring 192 | Button Spring Handle to Container Connecting Pole 194 | Horizontally Opposed Cylindrical Openings 196 | User 300 | User's Hand 400 | Load Force CFL 410 | Conventional Horizontal Handle 420 | Effort Force CFE 430 | Palm to Wrist Distance 440 | Conventional Wrist Torque CWt 460 | Load Force PFL 500 | Paddle Assisted Effort Force PFE 510 | Palm to Wrist Distance 520 | Palm to Paddle Distance 530 | Container to Handle Distance 540 | Forearm Wrist Torque FWt 560 | Center of Grip 600 | Load Force CGFL 610 | Effort Force CGFE 620 | Container to Handle Distance 630 | Center of Handle To Grip Distance 640 | Carry Handle Load Force CHFL 700 | Carry Handle Effort Force CHFE 710 | Palm to Wrist Distance 720 | Container to Handle Distance 730 | Carry Handle Force Fulcrum CHFF 740

### DETAILED DESCRIPTION

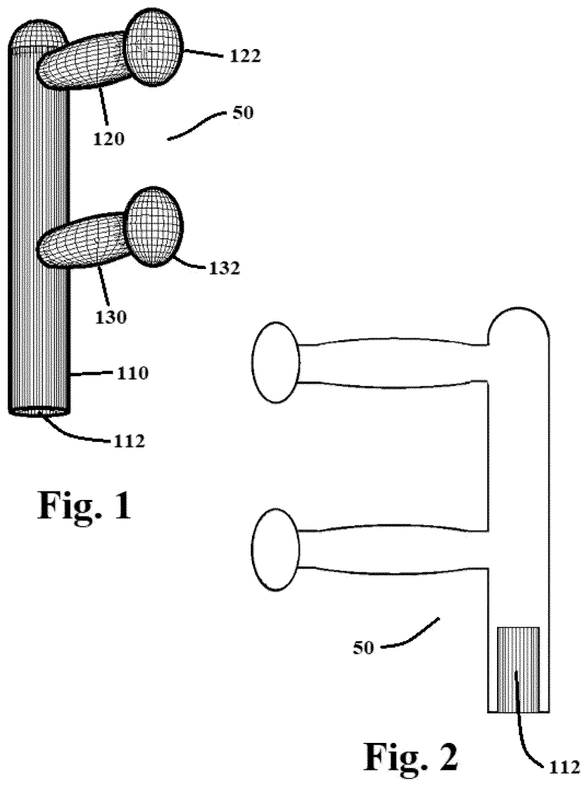

### Specification (FIGS. 1-13, 15)

FIG. 1 is an isometric front view of a Double Horizontal Handle Apparatus 50 utilized in an embodiment of the Multipurpose Ergonomic Dustpan. The Double Handle Apparatus 50 partially consists of a Handle Stem 110 with a Pole Reciever Hole 112 located at the bottom. The Handle Stem 110 is a cylinder with an extended length and oriented such that it's axis is parallel to the z axis. The Handle Stem 110 is constructed out of a solid material such as, but not limited to, injection molded plastic, composite materials, rubber, steel or aluminum. The Pole Reciever 112 is a hollow tube shaped cylindrical opening at the bottom end of the Handle Stem 110. The axis of the cylindrical opening runs parallel with the z axis.

Extending perpendicularly from the z axis from near the top section of the Handle Stem 110 is a Sweep Handle 120. The Sweep Handle 120 is attached to or molded as a part of the Handle Stem 110. The Sweep Handle 120 is constructed out of a similar material set as the Handle Stem 110. A Sweep Handle Grip Retention Knob 122 resides at the distal end of the Sweep Handle 120. The Sweep Handle 120 can be a cylinder with a circumference and length appropriate for hand grips ranging in size from small child to large adult. Some embodiments feature this handle with a circumference that gradiates wider toward the middle from the edges, for ergonomic grip comfort. Other common hand grip designs (not illustrated) can also be used such as, but not limited to, a finger molded grip or a foam cover that fits over the Sweep Handle 120 structure.

The Sweep Handle Knob 122 is attached to or molded as a part of the distal end of the Sweep Handle 120. The Sweep Handle Knob 122 is a sphere or spheroid with a circumference that is greater than the circumference of the distal end of the Sweep Handle 120. The Sweep Handle Knob 122 may also feature a foam cover or be made out of a different solid material than the Sweep Handle 120 such as, but not limited to, rubber, synthetic plasitics or a durable foam. Shapes other than a spheroid may be used for the Sweep Handle Knob 122.

Extending perpendicularly from the Handle Stem 110 below the Sweep Handle 120 is a Carry Handle 130. The Carry Handle 130 and the Sweep Handle 120 have similar material attributes. The Carry Handle 130 is connected to or molded as a part of the Handle Stem 110. Like the Sweep Handle 120, the Carry Handle 130 is designed to recieve the grip of a hand. The Carry Handle 130 can extend along the same axis as the Sweep Handle 120. The Carry Handle 130 is located a distance below the Sweep Handle 130 that is within the grasp of an open hand from the end of the thumb to end of pinky finger of a person ranging from small child to large adult.

In some embodiments, the Carry Handle 130 can be a different size, grip mold/shape or made of a different material than the Sweep Handle 120. A Carry Handle Grip Retention Knob 132 is attached to or molded as a part of the distal end of the Carry Handle 130. The Carry Handle Knob 132 has similar attributes to the Sweep Handle Knob 122. In some embodiments, the Carry Handle Knob 132 can be a different size, shape or made of a different material than the Sweep Handle Knob 122.

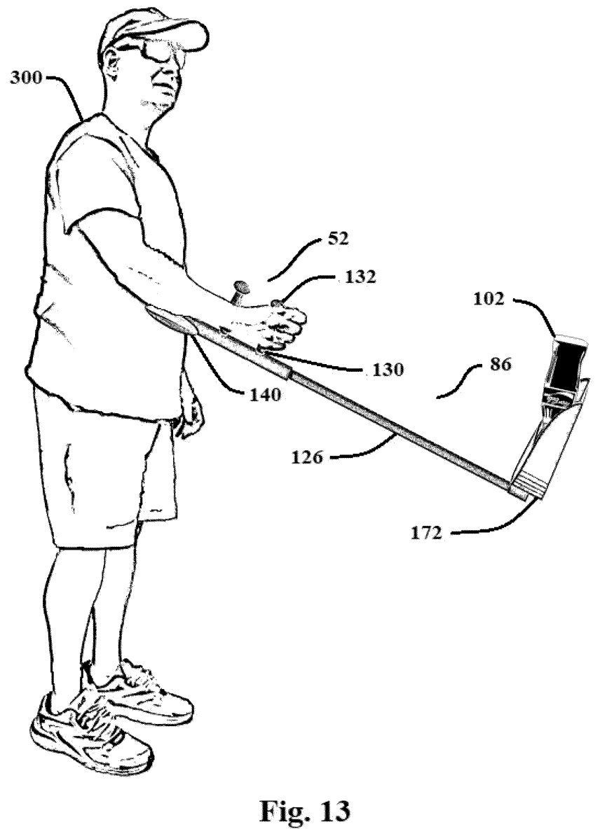

FIG. 2 is a cross sectional side view of the Double Handle Apparatus 50. The vertical length of Pole Reciever 112 is sufficient to accept the Handle to Dustpan Connecting Pole 126 (FIG. 13) and provide stuctural integrity for both adhesive and mechanical purposes.

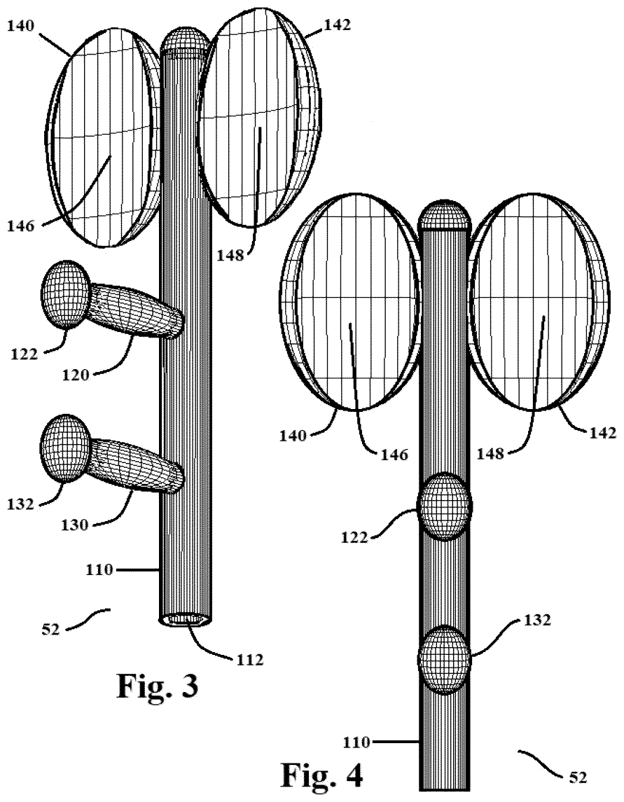

FIG. 3 is an isometric front view of a Double Horizontal Handle with Forearm Supports Apparatus 52 utilized in another embodiment of the Multipurpose Ergonomic Dustpan. This apparatus consists of the same parts and materials described in FIG. 1 with an addition of an upper portion that consists of an extended Handle Stem 110, a Left Forearm Support Paddle 140 and a Right Forearm Support Paddle 142. A paddle is defined as a blade which is defined as an object with a flat elongated surface. For example, the paddle of a paddle wheel is a blade that pushes against water. Similarly, the forearm support paddle pushes against the forearm.

The narrow side of the paddles are connected at their edges on either side of the extended Handle Stem 110. The broad face of the forearm paddle can be perpendicular to the axis of the Carry Handle 130 in relation to the z axis. Each of the paddle's width ranges depending on the user's forearm width and preference. Each of the paddle's height or length is long enough provide ample contact with the forearm without touching the palm when the Sweep Handle 120 is grasped by various users. And similarly without touching the tip of the elbow when the Carry Handle 130 is grasped by various sized users.

In some embodiments, embedded in the front side of each paddle front (the elongated flat side of the blade) is one or more vertically oriented concave surface lengths, a Left Forearm Ergonomic Contour 146 and a Right Forearm Ergonomic Contour 148. The concave indentation, designed to ergonomically fit the shape of a forearm, is deeper in the middle and tapers to a more shallow depth at the edges along the x axis for each paddle.

FIG. 4 is a front plan view of the Forearm Supports Apparatus 52 introduced with FIG. 3.

FIG. 5 is a top plan view of the Forearm Supports Apparatus 52 introduced with FIG. 3. The Left Ergonomic Contour 146 and Right Ergonomic Contour 148 are evident from this perspective.

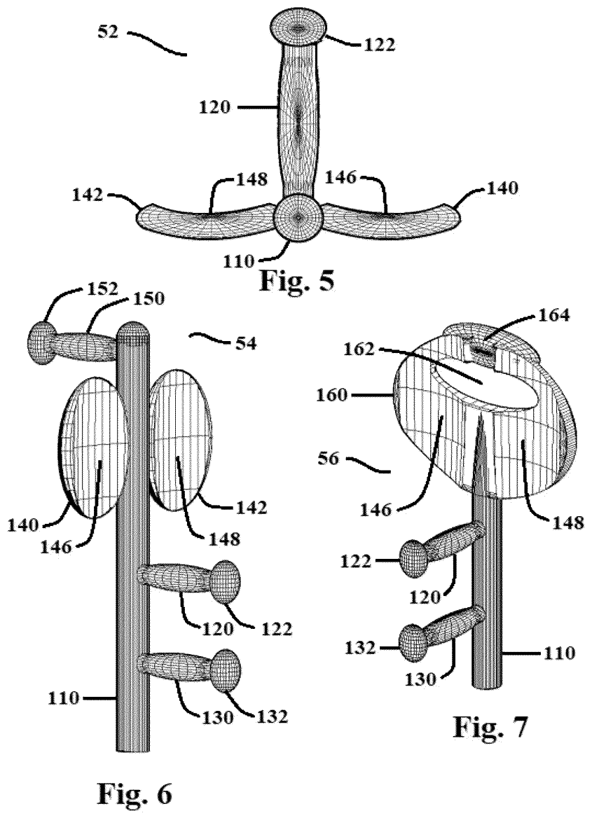

FIG. 6 is an isometric front view of a Triple Horizontal Handle with Forearm Supports Apparatus 54 suitable for use with some embodiments of the Multipurpose Ergonomic Dustpan. This apparatus consists of the same parts and materials as the Forearm Supports Apparatus 52 of FIG. 3 with an addition of an upper portion that consists of a slightly extended Handle Stem 110 and a Dolly Handle 150 extending from the extended upper section of the Handle Stem 110. The Dolly Handle 150 is attached to or molded into the upper section of the extended Handle Stem 110. The Dolly Handle 150 with a Dolly Handle Grip Retention Knob 152 at it's distal end has similar attributes to the Sweep Handle 120 and the Sweep Handle Knob 122 described in FIG. 1.

FIG. 7 is an isometric front view of a Double Horizontal Handle with Embedded Handle in Forearm Supports Apparatus 56. This apparatus consists of the same parts and materials as the Forearm Supports Apparatus 52 of FIG. 3. In this embodiment, the Left Forearem Paddle 140 and Right Forearm Paddle 142 are replaced with a single paddle/blade, the Top Paddle 160. The Top Paddle 160 spans across the top of the Handle Stem 110. The Top Paddle 160 can be embedded with the Left Forearm Contour 146 and the Right Forearm Contour 148.

A horizontal hand sized hole or oval for various users, Paddle Grip Opening 162, is located near the top edge of the Top Paddle 160. The distance from the top of the Paddle Grip Opening 162 to the top of the Top Paddle 160 is comensurate with the grip of various users. In some embodiments, a Top Handle Grip 164 spans the Top Paddle 160 above the Paddle Grip Opening 162. The Top Handle Grip 164 is spheroid or cylinder shape intended to fit the grip of various users. The Top Handle Grip 164 can be configured out of the various set of materials previously described in relation to the Sweep Handle 120.

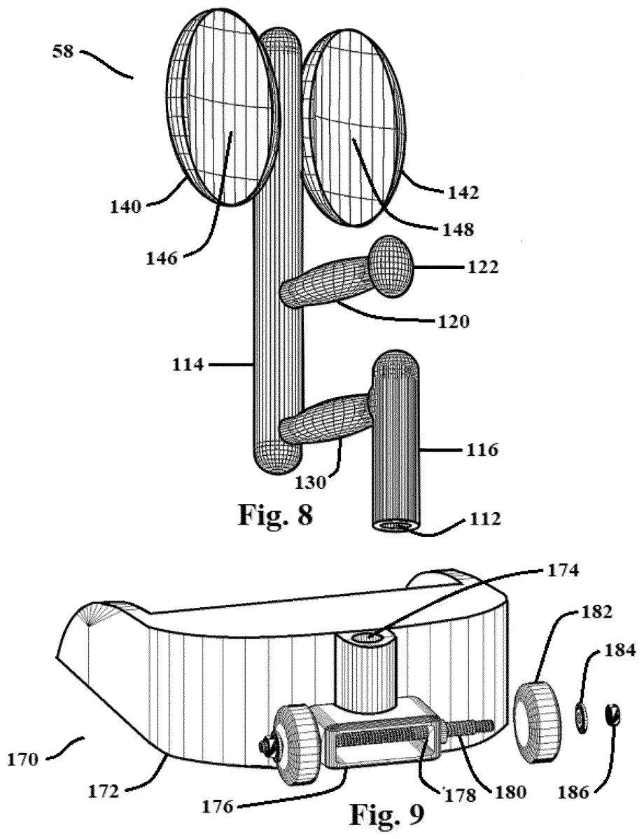

FIG. 8 is an isometric front view of a Double Horizontal Handle with Back Paddle Apparatus 58. This is a variation of the Forearm Supports Apparatus 52. The Handle Stem 110 is split at the location of the Carry Handle 130 such that it creates an Upper Handle Stem 114 and a Lower Handle Stem 116 with Pole Reciever 112. The Upper Handle Stem 114 remains connected to the Carry Handle 130. The Sweep Handle 120, the Left Forearm Paddle 140 and the Right Forearm Paddle 142 similarly remain in the same locations as previously described. The Lower Handle Stem 116 replaces the Carry Handle Knob 132 such that the Pole Reciever 112 faces downward in the z direction as in the Forearm Supports Apparatus 52.

FIG. 9 is an exploded isometric rear view of a Wheeled Ground Item Container 170. Incorporated into or attached to a conventional Ground Item Container 172 with a Ground Item Container Pole Reciever 174 is a hollowed Ground Item Container Axle Housing 176 located below the Container Pole Reciever 174. The Axle Housing 176 has two opposed cylindrical Ground Item Container Axle Housing Axle Holes 178 along the x axis. The Axle Housing Holes 178 recieve the Ground Item Container Axle 180 such that the length of the axle is parallel to the x axis. The Container Axle 180 has threaded ends such that a Ground Item Container Wheel 182 can be secured on either end by means of a Ground Item Container Axle Washer 184 and a Ground Item Container Axle Nut 186.

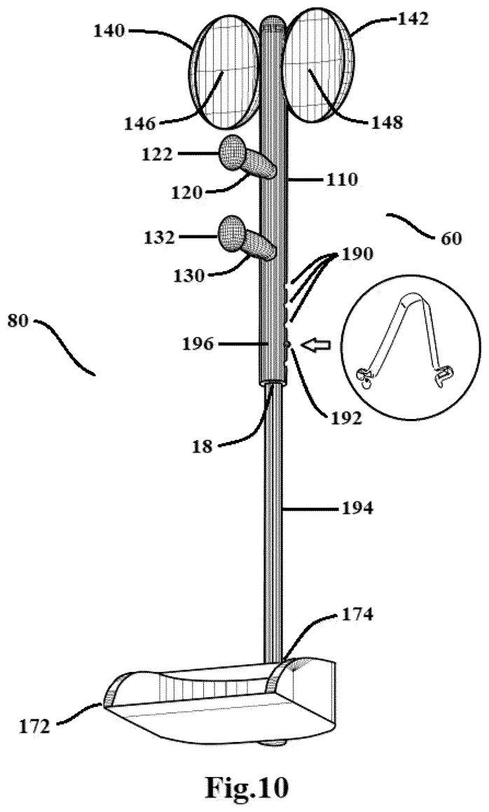

FIG. 10 is an isometric front view of a Spring Button Telescoping Double Handle with Forearm Supports Ergonomic and Therapeutic Lobby Dustpan 80. The device can be configured with the various handle apparatus perviously disclosed. In this embodiment a modification to the Forearm Supports Apparatus 52 is shown, a Double Horizontal Handle with Forearm Supports Telescoping Spring Button Apparatus 60.

The modification to this and other disclosed handle apparatus is an extension downward of the Handle Stem 110 such that the location of the ceiling of the Pole Receiver 112 remains in it's original postion. The distance extended is comensurate with the difference in relaxed arm hand height from the ground of the different sized users. The Telescoping Pole Reciever 118 is therefore a deeper pole receiver than the Pole Receiver 112. The Pole Receiver 118 is able to accommodate vertical adjustment of the Button Spring Handle to Container Connecting Pole 194.

Embedded in the Pole Receiver 118 are sets of horizontally opposed cylindrical openings, Handle Stem Spring Button Receiving Holes 190. The Button Receiving Holes 190's diameter are slighty larger than the diameter of the buttons on an Outward Protruding Button Spring 192. The Button Recieving Holes 190 sets are arranged along the vertical length of the Pole Reciever 118.

The Button Spring Pole 194 is a hollow cylinder or pole that can be constructed out of various solid materials including, but not limited to, metals, composites, plastics or other usable durable materials. The Button Spring Pole 194's outside diameter is slightly smaller that the inside diameter of the Pole Reciever 118. Near the top portion of the Button Spring Pole 194 is one set of horizontally opposed openings, Horizontally Opposed Cylindrical Openings 196. The Button Spring 192 is a conventional lever spring with outward protuding buttons. The extended spring length is sightly larger than the inside diameter of the Button Spring Pole 194.

The assembly of the Spring Button Dustpan 80 consists of attaching the lower section of the Button Spring Pole 194 to the Ground Item Container 172. The pole is inserted into the marginally larger diameter Container Pole Receiver 174 and adhered by glue or other common attachment methods (not shown). The Button Spring 192 is inserted inside the upper section of the Button Spring Pole 194 such that the Button Spring 192's buttons penetrate the Cylindrical Openings 196. The Button Spring Pole 194 is then inserted into the slightly larger diameter Pole Receiver 118 of the Telescoping Spring Button Apparatus 60.

Next, the Buttons Spring 192's buttons are simultaneously pressed inward during an insertion process such that the distance between the outer edge of the buttons is less than the cylindrical inner diameter of the Pole Receiver 118. When the preceding step is accomplished, the pole is adjusted until the buttons of the Button Spring 192 penetrate any set of the Button Recieving Holes 190.

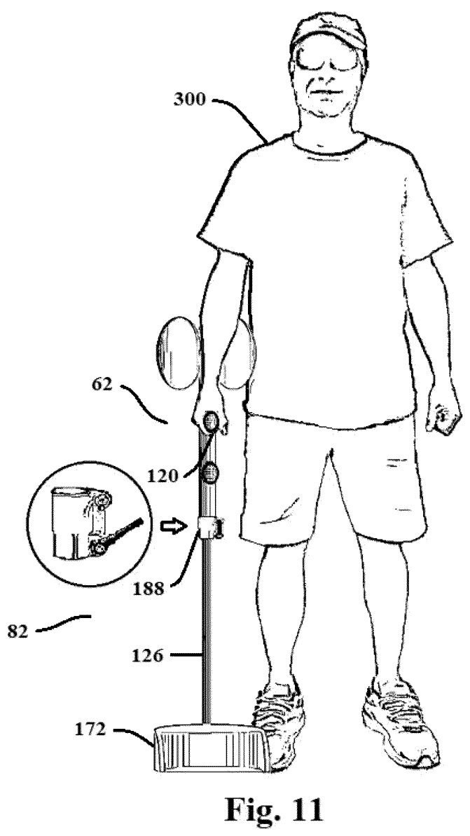

FIG. 11 is a front view diagram of a User 300 holding an adjusted Lever Clamp Telescoping Horizontal Handles with Forearm Supports Ergonomic and Therapeutic Lobby Dustpan 82. A Double Horizontal Handle with Forearm Supports Telescoping Apparatus 62 has an extended lower cylindrical cavity as in the Telescoping Spring Button Apparatus 60. Attached at the bottom of the Telescoping Ergonomic Dustpan 82 is a conventional Lever Action Tube Squeeze Clamp 188 with an upper tube receiver and a lower tube tube receiver. The lower tube receiver in this embodiment is slightly larger than the outside diameter of the Connecting Pole 126. The Lever Clamp 188's upper tube receiver is fitted over and securely fixed by common methods to the bottom of the Forearm Supports Telescoping Apparatus 62.

The Connecting Pole 126 is a cylinder or pole with a diameter and length commensurate with a handle to dustpan connecting pole of a conventional long handled dustpan. The Connecting Pole 126 is inserted though the lower tube receiver into the lower cavity of the Forearm Supports Telescoping Apparatus 62. The lower end of the Connecting Pole 126 is connected to the Ground Item Container 172 in the same manner the as described for the Spring Button Ergonomic Dustpan 80. As with conventional lever action squeeze clamps, the lever angle controls the diameter of the lower portion such that one position squeezes a cylinder or like shape. When properly operated, the Connecting Pole 126 locks in relation with the Lever Clamp 188.

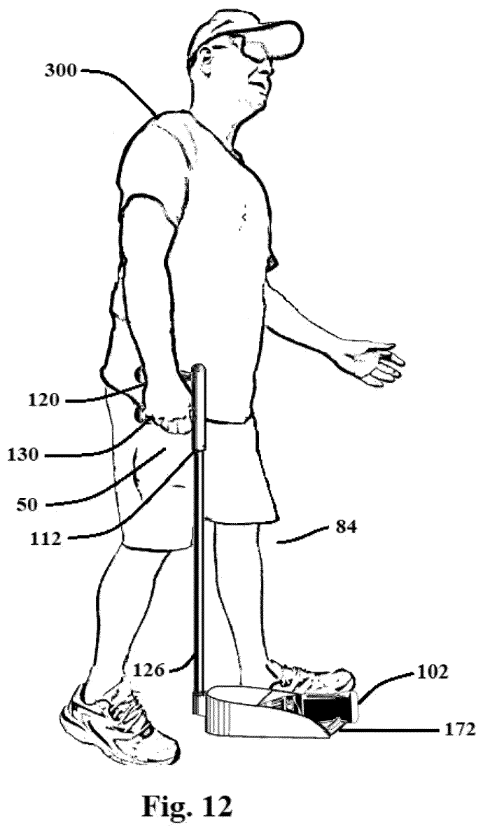

FIG. 12 contains a side view of a Double Horizontal Handle Ergonomic and Therapeutic Lobby Dustpan 84. The upper section of the Connecting Pole 126 is inserted into the Pole Reciever 112 of the Double Handle Apparatus 50 and secured with common methods such as glue or hardware. They may also be molded as one piece. The lower section of the Connecting Pole 126 is connected to the Ground Item Container 172 with common methods and may also be molded as one piece.

FIG. 13 contains a side view of a Double Horizontal Handle with Forearm Supports Ergonomic and Therapeutic Lobby Dustpan 86. The Forearm Supports Apparatus 52, Connecting Pole 126 and Ground Item Container 172 are assembled in accordance to methods disclosed for the Double Handle Dustpan 84 of FIG. 12.

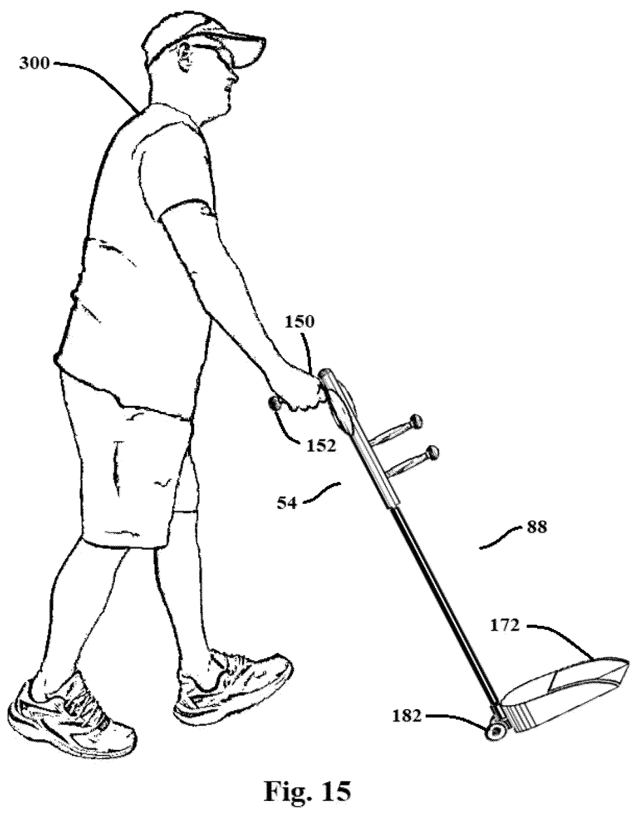

FIG. 15 contains a side view diagram of a Wheeled Triple Horizontal Handle with Forearm Supports Ergonomic and Therapeutic Lobby Dustpan 88. The upper section of the Connecting Pole 126 is inserted into the Triple Handle Apparatus 54 and affixed with common methods. The Wheeled Ground Item Container 170 is affixed to the lower section of the Connecting Pole 126 such that the handles of the Triple Handle Apparatus 54 are parallel with the y axis of the Wheeled Ground Item Container 170. Other arrangements for the postion of top handle are possible when the Embedded Handle Apparatus 56 is incorporated as the handle. The separate part/s may be molded into a single piece.

### Operation (FIGS. 11-15)

There are several operational modes readily available to the User 300 after proper adjustment or fitment. These are use in conjunction with a broom or rake (sweeping), carrying, lifting, dumping, transport, alternate grips, use without a supporting device and a strategy to keep contents in, in less than perfect circumstances.

### Adjusting

FIG. 11 is a front view diagram of the User 300 holding the Sweep Handle 120 of an adjusted Lever Clamp Ergonomic Dustpan 82. The User 300 adjusts the vertical length of the Lever Clamp Dustpan 82 such that Ground Item Container 172 lay flat on the ground while the Sweep Handle 120 is approximately the same vertical height of the palm of the User 300's hand with a relaxed or slightly bent arm. Preference, modes or other circumstances may require a different user adjustment.

The adjustment is done by turning the lever of the Lever Clamp 188 about it's fulcrum to its unlocked position. Then while holding the Forearm Supports Telescoping Apparatus 62 with one hand, the User 300 grasps the Connecting Pole 126 with the other hand to adjust the vertical length and relative angle of the Ground Item Container 172 with respect to the device's z axis to their preference. Finally, the User 300 turns the lever of the Lever Clamp 188 about it's fulcrum to its locked position. With the adjustment complete, the User 300 can properly operate the Lever Clamp Dustpan 82.

Adjustment of the Spring Button Dustpan 80 of FIG. 10 is done in a similar fashion as the adjustment of the Lever Clamp Dustpan 82. Instead of operating the lever clamp, the user pushes the Button Spring 192s inward such that the buttons outside edge breaches the inside diameter of Pole Receiver 118. The user then slighly rotates the Button Spring Pole 194 with respect to the z axis, followed by a vertical adjustment. When the user deems an appropriate set of Button Receiving Holes 190, the user then reverses the z axis rotation to set the Button Spring 192s into the Button Receiving Holes 190 to lock the device into position.

### Sweeping Action

When various embodiments of the Multipurpose Ergonomic Dustpan are used in conjunction with a sweeping device operated by the other arm, the User 300 grasps the Sweep Handle 120 and lifts the device slightly off the ground. Then the User 300 chooses an appropriate location around the perimeter of the body and lets the Ground Item Container 172 fall to a ground such that it's bottom lay flat on the ground. Next the User 300 may rotate the postition of the Ground Item Container 172 to fine tune an advantageous postion for sweeping a particular item or items into the front opening of the Ground Item Container 172.

In designs with forearm support such as the Forearm Supports Dustpan 86 of FIG. 13, a support paddle can also engage the forearm and the outside of the grip can engage the Sweep Handle Knob 122 for added stability. This is done while walking short distances, making brief lifts and/or angle adjustments of the Ground Item Container 172.

### Carrying

FIG. 12 is a side view diagram of the User 300 carrying the Double Handle Dustpan 84. The User 300 carries the Double Handle Dustpan 84 by grasping the Carry Handle 130 and lifting the Double Handle Dustpan 84 a short distance off the ground. Access to the lower Carry Handle 130 can be done by slightly bending over, opening the hand such that the tips of the fingers touch the Carry Handle 130 then grasping it to lift . . . or a combination of both methods.

While carrying, the inside of the User 300's wrist makes gentle contact with the Sweep Handle 120 for therapy and to increase stability. In appropriate designs such as the Forearm Supports Dustpan 86 of FIG. 13, the user may also slightly tilt back the pan and engage a forearm support paddle with the forearm and the Carry Handle Knob 132 with the edge of the grip to increase steadiness.

### Lifting

FIG. 13 is a side view diagram of the User 300 lifting a Forearm Supports Dustpan 86. The User 300 first lightly grasps the Carry Handle 130, then lifts the Forearm Supports Dustpan 86 in front of their body such that the z axis of the dustpan generally rotates about it's x axis. As the User 300 lifts the device with their arm, the back of the User 300's forearm makes contact with the Left Forearm Paddle 140.

When the User 300's forearm comes into contact with the Left Forearm Paddle 140, the exterior edge of the thumb and forefinger ring shape created by the User 300's grip can come into contact with the Carry Handle Knob 132. When using the left arm to lift, the Right Forearm Paddle 142 makes contact with the forearm. The Left Support Paddle 140 or Right Support Paddle 142 and the Carry Handle Knob 132 can connect the forearm to the hand. This connetion embodies as a lever arm that offers significant leverage advantage as well a reduction in the grip force necessary to support the load.

### Dumping

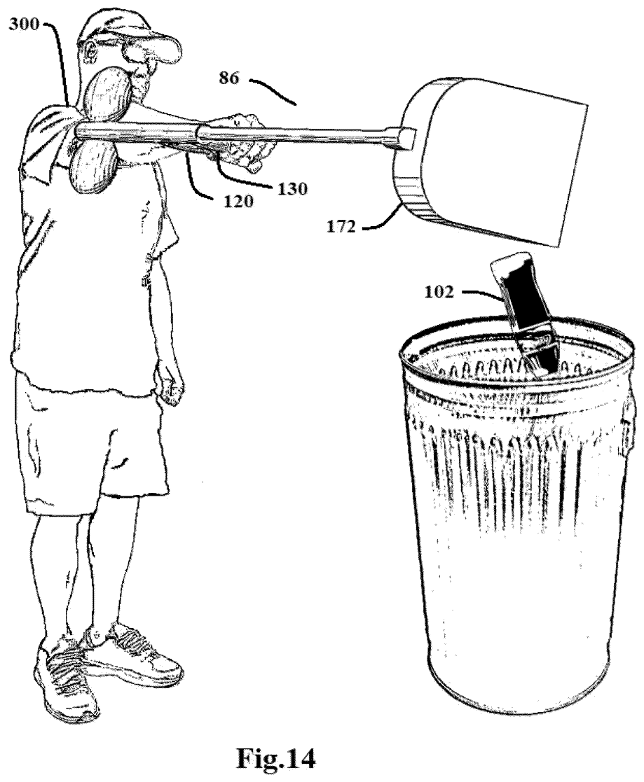

FIG. 14 is an isometric front view diagram of dumping the Forearm Supports Dustpan 86. After the User 300 has lifted the Forearm Supports Dustpan 86 to the desired height and position, the User 300's arm is rotated inward. This inward rotation action causes the Forearm Supports Dustpan 86 to rotate inward. During the rotation, the inside of the User 300's wrist gradiates into firm contact with the Sweep Handle 120. This is because the gravitational force vector changes in relation to the Forearm Supports Dustpan 86. The new relationship between the User 300 and the Forearm Supports Dustpan 86 provides leverage, stability and therapuetic advantages. Next, the Forearm Supports Dustpan 86 is rotated further, and posibily shaken, until gravity liberates the Ground Target 102 from the Ground Item Container 172.

### Transporting

FIG. 15 is a side view diagram of the User 300 transporting the Wheeled Dustpan 88. To transport the Wheeled Dustpan 88 without carrying, the User 300 can lightly grasp the Dolly Handle 150 and push downward so the z axis of the Wheeled Ergonomic Dustpan 88 rotates about x axis of the User 300. When pushing downward, the pinky finger's outer edge cam make contact with the Dolly Handle Grip Retention Knob 152. This action engages one or more Ground Item Container Wheel 182s with the ground while the Ground Item Container 172 is freed from contact with the ground. The User 300 generally pushes or pulls the Dolly Handle 150 in their y axis direction to transport or turn the Wheeled Dustpan 88 which may contain ground targets.

### Alternate Grip

When the Embedded Handle Apparatus 56 of FIG. 7 is utilized in various embodiments of the Multipurpose Ergonomic Dustpan, the user grasps the Top Handle Grip 164 after inserting the fingers through Paddle Grip Opening 162 from either the front or back side. There are two reasons for using a top handle grip such as Top Handle Grip 164. The first is to give the user alternate rotated grip position choices when used in conjunction with a sweeping device. The second is as an alternate handle design to be grasped during transport such as with the Wheeled Ergonomic Dustpan 88 of FIG. 15.

### Scooping

FIG. 13 is also a side view diagram of the User 300 operating a Forearm Supports Dustpan 86 without a supporting sweeping device used by the other arm. In this mode of operation the user can lightly grasp the Carry Handle 130 and swing the Forearm Supports Dustpan 86 from the User 300s back to front to scoop the Ground Target 102. The User 300's forearm comes into contact with a forearm paddle and the grip with the Carry Handle Knob 132 for leverage advanage.

The illustration depicts the part of the action after the user has scooped the Ground Target 102. The user may bend over slightly so that the bottom of the Ground Item Container 172 comes close to, or scrapes, the ground slightly. This operation may also be performed with minimal or even no swing if the user is walking and dips slightly mid stride just before passing the ground target. The height may be adjusted in some embodiments so that the bottom of the Ground Item Container 172 touches the ground as the User 300 grasps the Carry Handle 130 when the arm is near or at a relaxed position.

Holding Contents In with Sweeping Device Assistance

Another mode of operation, not illustrated, is when the user lays the head of a sweeping device on top of the Ground Item Container 172's contents as a strategy to keep them from spilling. On a windy day, light items such as napkins or paper will simply blow away if measures are not taken while sweeping, carrying and transporting. Another example is when the user overloads the Ground Item Container 172 in the interest of saving a trip to a larger container.

Further, lifting . . . then dumping the contents of the Ground Item Container 172 into a tall conatiner such as a dumpster or garbage container without spilling can be challenging. To keep the contents in the Ground Item Container 172 in these type of situations, the user lays the head of the sweeping device across the top of the items in the Ground Item Container 172 and lifts and/or dumps using some embodiments of the Mulipurpose Ergonomic Dustpan and the sweeping device in unison.

### Advantages

The new advantages the embodiments of the Multipurpose Ergonomic Dustpan offer a user are extensive. This is due to addressing the multitude of unique operations a lobby dustpan performs, body physiology and applying synergistic design. Strategically placed handles dovetail into each other and are used in different ways to provide easily accessable, advantageous and strategic grip options as well as a useful leverage system. Open access offset forearm supports are fitted to human anotomy and provide additional leverage systems. The separte components work together and do not interfere with operation across the modes. The options offer useful ways to relieve the work load, useful open access leverage systems, therapy for overused muscles and a combined ergonomic effect that results in welcome new advantages for ground item collection.

### Carrying Advantage

In FIG. 12 the User 300 is carrying a Double Handle Dustpan 84 with a relaxed arm. The user does not have to flex and bend their arm to lift the Double Handle Dustpan 84 while walking. This translates to less energy exerted by the user to execute this task, thus reducing strain. The ergonomic advantage compounds itself the farther the user carries the device.

### Carrying Therapuetic Advantage

Some of the energy from different modes of operation in the various embodiments of the Multipurpose Ergonomic Dustpans is used to provide therapuetic pressure point relief massage to the area inside the wrist. Pressure point massage is about identifying trigger points for pain and applying targeted pressure to the trigger points to help release tight muscles and relieve pain.

The problem is over worked/stressed finger, wrist and forearm muscles due to the severe mechanical disadvantage. A long vertical handle requires the user to flex the wrist and forearm just to grasp it. Then all duties require extensive use of the wrist, the fingers and the forearm due to this mechanical disadvantage. Extensive use leads to physiological problems such as fatique, strains and even more permananent problems such as Carpel Tunnel Syndrome. Embodiments of the Multipurpose Ergonomic Dustpan not only relieve this strain, but also provide therapy.

While carrying, the Sweep Handle 120 gently presses into the inside of the wrist. This is because embodiments of the Multipurpose Ergonomic Dustpan are carried at the side of the body which requires the arm to angle away from the body. Therefore, when the Carry Handle 130 is grasped, the wrist's natural position is closer to the body than the grip. Since the inside of the wrist is a pressure point, carrying certain embodiments of the Multipurpose Ergonomic Dustpan can be a soothing experience. As with the ergonomic advantage of carrying this genus of device, the therapeutic advantage also compounds itself the farther the user travels.

### Lifting Wrist Force Advantage

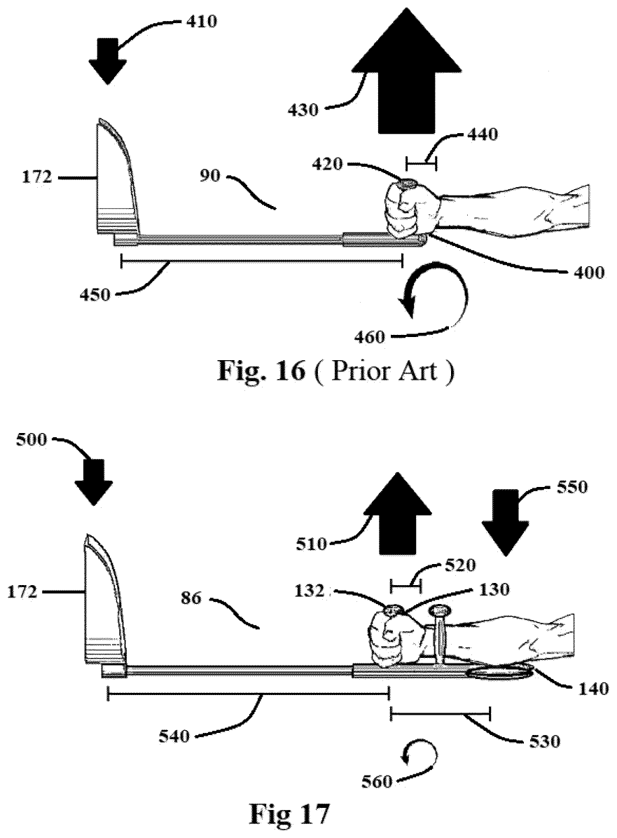

FIG. 16 illustrates the relavant forces the User 300's wrist will endure when lifting a Conventional Horizontal Handle Long Handle Dustpan 90. Popular long handle dustpans can feature a single vertical or horizontal handle at the upper end of a vertical pole. To acheive a lift of the refuse container with these devices produces significant torque on the wrist. The muscles that operate the wrist are required to flex such that the wrist will not bend and a grip with a firmness that prevents the handle from slipping within the user's grasp.

In a class 3 lever system the effort force is located between the fulcrum on one end and the load force on the other end. The load arm distance is the distance between the ends, the load and the fulcrum. The effort arm distance is the distance between the effort and the fulcrum. A bending movement of an arm at an elbow utilizes a class 3 lever system where a forearm is a lever arm, an elbow is the fulcrum, an attachment of the bicep to the forearm bones is the effort and a hand is the load.

A wrist joint connects the hand to the end of the forearm. The hand and wrist are also a class 3 lever system with the palm supplying the load force, one side of the wrist acting as the fulcrum and the other side of the wrist connected to the forearm muscles acting as the effort force. When lifting the arm and holding something in the hand, the forearm muscles must counteract the force of gravity upon the hand and the item being lifted. When something is held that becomes an extension of the hand, the load arm is extended, thus mechanical advantage is decreased.

The location of a conventional lobby dustpan's ground item container is an order of magnitude farther than the lever arm distance from the wrist to the palm of the hand. Also, the dust pan can hold significant loads which means the comparitive torque the wrist must withstand is enormous. Not only must the wrist remain stiff, but an extra tight grip is required to maintain stability. Even short term use with a moderate load in the ground item container can cause immediate injury to the muscles that operate the hand and wrist.

One way to calculate the torque on the wrist when the user lifts a Conventional Dustpan 90 to a horizontal postion is to consider the Conventional Dustpan 90 and the User's Hand 400 as a lever arm in a class 3 lever system. The Refuse Container 172 provides the Load Force CFL 410. The Conventional Horizontal Handle 420 conteracts with the Effort Force CFE 430, and the wrist is the fulcrum. After calculating the Effort Force CFE 430, a distance from the handle to the wrist, Palm to Wrist Distance 440, is used to calculate the torque, Conventional Wrist Torque CWt 460.

$$MA ( Mechanical Advantage ) = ( Effort Arm Distance ) / ( Load Arm Distance )$$

$$Effort Arm Distance = Palm to Wrist Distance 440 = A / 4$$

$$Container to Handle Distance 450 = 3 * A$$

$$Load Arm Distance = ( Palm / Wrist Distance 440 ) + ( Container / Handle Distance 450 ) = ( A / 4 + 3 A )$$

$$MA = ( A / 4 ) / ( 3 A + A / 4 )$$

$$MA = ( \text{.25} A ) / ( 3.25 A )$$

$$MA = \text{.0769}$$

$$MA ( Mechanical Advantage ) = ( Load Force ) / ( Effort Force )$$

$$Effort Force = ( Load Force ) / MA$$

$$Load Force CFL 410 = Mg$$

$$Effort Force CFE 430 = Mg / \text{.0769}$$

$$Effort Force CFE 430 = 13 Mg$$

$$t ( torque ) = r ( radius ) * F ( Force )$$

$$t = ( Palm to Wrist Distance 440 ) * ( Effort Force CFE 430 )$$

$$t = A / 4 * 13 Mg$$

$$t = Conventional Wrist Torque CWt 460 = 3.25 A Mg$$

For cross reference, the torque on the wrist is examined from the viewpoint of a simple torque system.

$$t ( torque ) = r ( radius ) * F ( Force )$$

$$r = ( Container to Handle Distance 450 + Palm to Wrist Distance 440 )$$

$$F = Load Force CFL 410 = Mg$$

$$t = ( 3 A + A / 4 ) * Mg$$

$$t = Conventional Wrist Torque CWt 460 = 3.25 A Mg$$

FIG. 17 illustrates the relavant forces the User 300's wrist must endure when lifting a Forearm Supports Dustpan 86. Similar to the Conventional Dustpan 90, the torque on the wrist is calculated considering the Forearm Supports Dustpan 86 as a lever arm in a class 3 lever system. The Refuse Container 172 provides a Load Force PFL 500. The Carry Handle 130 and Carry Handle Knob 132 counter act with a Paddle Assisted Effort Force PFE 510 and the Left Forearm Support Paddle 140 is the fulcrum. After calculating the Paddle Effort Force PFE 510, the distance from the handle to the wrist, a Palm to Wrist Distance 520, is used to calulate torque.

$$MA ( Mechanical Advantage ) = ( Effort Arm Distance ) / ( Load Arm Distance )$$

$$Effort Arm Distance = Palm to Paddle Distance 530 = A$$

$$Container to Handle Distance 540 = 3 * A$$

$$Load Arm Distance = ( Container / Handle Distance 540 + Palm / Paddle Distance 530 ) = ( 3 A + A )$$

$$MA = A / ( 3 A + A )$$

$$MA = A / ( 4 A )$$

$$MA = \text{.25}$$

$$MA ( Mechanical Advantage ) = ( Load Force ) / ( Effort Force )$$

$$Effort Force = ( Load Force ) / MA$$

$$Load Force PFL 500 = Mg$$

$$Effort Force = Mg / \text{.25}$$

$$Paddle Effort Force PFE 510 = 4 Mg$$

$$t ( torque ) = r ( radius ) * F ( Force )$$

$$r = Palm to Wrist Distance 520 = A / 4$$

$$t = A / 4 * 4 Mg$$

$$t = Forearm Wrist Torque FWt 560 = A Mg$$

This calculation on an embodiment of the Multipurpose Ergonomic Dustpan is meant to show that there is a leverage advantage that reduces the torque on the wrist when compared to similar conventional devices. Different Carry Handle 130 locations and different paddle locations can result a longer effort arm and even less torque than demonsrated.

However, it should be clear that it is possible to greatly reduce the torque on the wrist when lifting an open access forearm support device. Here we compare fair estimates of 3.25 AMg for Conventional Wrist Torque CWt 460 to a Forearm Wrist Torque FWt 560 of AMg. A 70% reduction in wrist torque is a very significant and noticable ergonomic advantage that allows an average user to lift some embodiments of the Multipurpose Ergonomic Dustpan and it's contents with relative ease.

### Carry Grip Lift Advantage

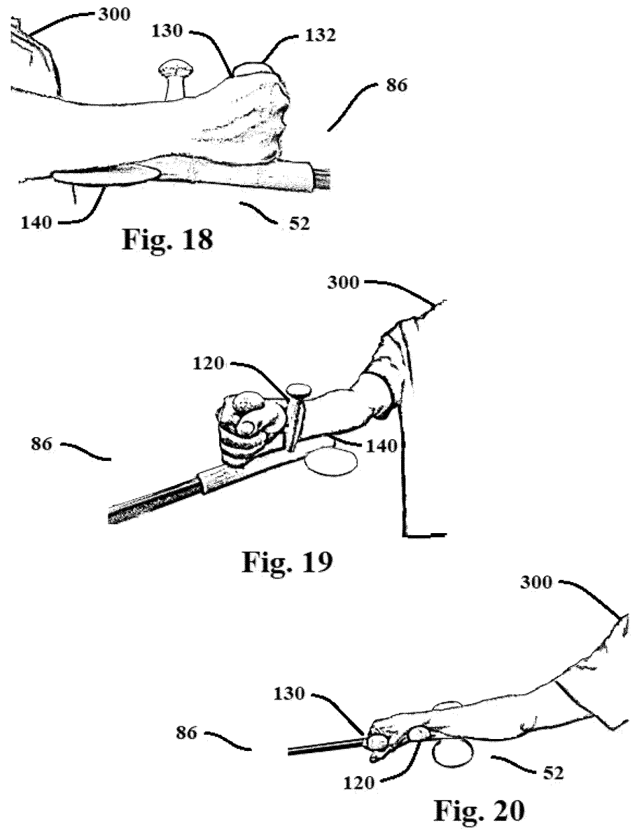

FIG. 18 is a close-up side view the User 300's arm and hand contact with the Forearm Supports Apparatus 52. A further advantage by means of the reduction of forces is that the Carry Handle Grip 130 enjoys a reduction in the forces the user must contend with to achieve a stable grip. This is because some of the force is transferred to the Left Forearm Paddle 140.

### Carry Handle Grip Retention Knob Lift Advantage

Additionally, the Carry Handle Knob 132 offers yet another grip advantage. This is because when lightly grasped, the exterior ring of the thumb and forefinger make contact with the underside (from a lifted perspective) of the Carry Handle Knob 132 (FIG. 18). This contact is directly opposed to the Paddle Effort Force PFE 510 acting on the fulcrum, Left Paddle 140. The force is transferred to the bone structure of the hand. Consequently and perhaps surprisingly, significant loads can be lifted using a light grip of just the thumb and forefinger having minimal contact with the Carry Handle 130.

### Force Transfer Advantage

FIG. 19 is a close-up isometric front view the User 300 starting to dump the Forearm Supports Dustpan 86. During this action, the fulcrum of the lever arm described in FIG. 17 is seamlessly transferred from the Left Paddle 140 to the Sweep Handle 120 where the Sweep Handle 120 makes contact with the inner portion of the wrist area. Because the dumping action results in the highest forces on the wrist, the instantaneous transfer of forces to a second strategic lever system is an operational and ergonomic advantage.

### Dumping Advantage

FIG. 20 is a close up side view of User 300's hand and wrist contact with the Forearm Supports Apparatus 52. When the lifted Forearm Supports Dustpan 86 is rotated 90 degrees about it's z axis, the Sweep Handle 120 fully becomes the fulcrum in a class 3 lever system. Although the effort arm is shorter than demonstrated before the transition, there is still a significant advantage when compared to conventional devices.

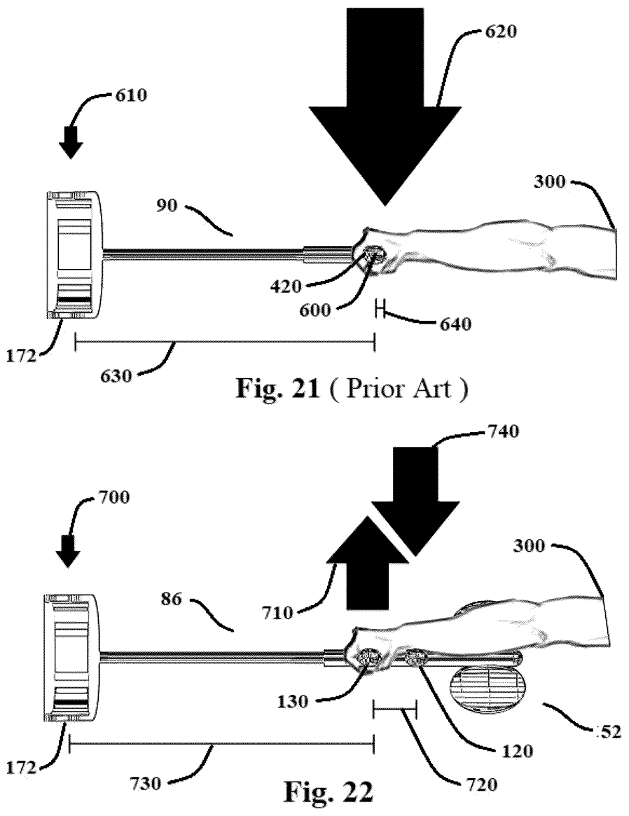

FIG. 21 is a side view force vector diagram of the lifted Conventional Dustpan 90 turned 90 degrees in relation to it's z axis. The User 300's hand is grasping the Conventional Horizontal Handle 420. The forces are addressed from the standpoint of a class 1 lever system where a fulcrum lies between the load and effort. In a class 1 lever system, the load arm is the distance from the load to the fulcrum and the effort arm is the distance from the fulcrum to the effort.

When the lifted Conventional Dustpan 90 is rotated 90 degrees about it's x axis, a Center of Grip 600 becomes an additional axis of rotation about the y axis of the turned device. The User 300's grip must counteract the torque it endures to maintain stability. The User 300 is contending with forces on both wrist and grip. It is not a “stretch” to say that an already strained system is near or at overload.

To calculate the force on the grip of the turned Conventional Dustpan 90, the Center of Grip 600 is considered the fulcrum of a class 1 lever system. The Refuse Conatainer 172 is the load with Load Force CGFL 610 and the grip, Conventional Horizontal Handle 420, is the Effort Force CGFE 620. Therefore, the Container to Handle Distance 630 is the load arm distance and a Center of Handle To Grip Distance 640 is the effort arm distance.

$$MA ( Mechanical Advantage ) = ( Effort Arm Distance ) / ( Load Arm Distance )$$

$$Effort Arm Distance = Center of Handle To Grip Distance 640 = A / 20$$

$$Load Arm Distance = Container to Handle Distance 630 = 3 * A$$

$$MA = ( A / 20 ) / ( 3 A )$$

$$MA = ( \text{.05} ) / 3$$

$$MA = \text{.017}$$

$$MA ( Mechanical Advantage ) = ( Load Force ) / ( Effort Force )$$

$$Effort Force = ( Load Force ) / MA$$

$$Load Force CGFL 610 = Mg$$

$$Effort Force = Mg / \text{.017}$$

$$Effort Force = Effort Force CGFE 620 = 60 * Mg$$

The User 300's grip must counteract Effort Force CGFE 620 with a force of friction between the User 300's palm and the Conventional Horizontal Handle 420 with a squeezing grip. The squeezing grip maximizes surface area contact so that the Effort Force CGFE 620 may be distributed more effectively. However since (60*Mg) is the threshold force, a greater force is most likely required by the user to maintain assured stability.

FIG. 22 is a side view force vector diagram of the Forearm Supports Dustpan 86 turned 90 degrees inward in relation to it's z axis. The User 300's arm is grasping the Forearm Supports Apparatus 52. The forces are addressed from the standpoint of a class 3 lever system where the effort is located between the load and the fulcrum. Here the Refuse Container 172 is the load with Carry Handle Load Force CHFL 700, the Carry Handle 130 is the effort with Carry Handle Effort Force CHFE 710 and the Sweep Handle 120 is the fulcrum.

$$MA ( Mechanical Advantage ) = ( Effort Arm Distance ) / ( Load Arm Distance )$$

$$Effort Arm Distance = Palm to Wrist Distance 720 = A / 4$$

$$Container to Handle Distance 730 = 3 * A$$

$$Load Arm Distance = ( Container to Handle Distance 730 + Palm to Wrist Distance 720 ) = ( 3 A + A / 4 )$$

$$MA = ( A / 4 ) / ( 3 A + A / 4 )$$

$$MA = ( \text{.25} A ) / ( 3.25 A )$$

$$MA = \text{.0769}$$

$$MA ( Mechanical Advantage ) = ( Load Force ) / ( Effort Force )$$

$$Effort Force = ( Load Force ) / MA$$

$$Load Force = Carry Handle Force CHFL 700 = Mg$$

$$Effort Force = Mg / \text{.0769}$$

$$Effort Force = Carry Handle Force CHFE 710 = 13 Mg$$

A review comparing the Effort Force CGFE 620 of 60 Mg to the Carry Handle Force CHFE 710 of 13 Mg reveals an 80% reduction the forces the grip must contend with when the conventional long handled dustpan is compared to an embodiment of the Multipurpose Ergonomic Dustpan while dumping. The significant reduction of forces required to dump is an ergonomic advantage.

### No Squeezed Grip Needed Advantage

Also of note is that a squeezing grip is not required to counteract the force of the load. A normal grip, even open grasp is all that is required to maintain stabilty when a lifted Multipurpose Ergonomic Dustpan is turned 90 degrees or more to deposit it's contents in a container whose edges are above the ground.

In totality, when the conventional dustpan is turned, the hand grip endures a force of 60 Mg while the wrist is remaining stiff against a force of 13 Mg (FIG. 16) for a total distribution of 73 Mg across the hand and wrist muscles combined. Comparing, embodiments of the Multipurpose Ergonomic Dustpan meets a hand grip of ~13 Mg while a Carry Handle Force Fulcrum CHFF 740 Force is mostly supported by larger forearm muscles and the bicep. This is because the wrist is supported through the bones in the forearm which is supported at the elbow with upper arm muscles. The 82% reduction in the combined forces the hand and wrist muscles must undergo while dumping indicate an ergonomic advantage.

### Therapeutic Dumping Advantage

When a lifted Multipurpose Ergonomic Dustpan is turned such that the Sweep Handle 120 is below the wrist there is also modified therapeutic benefit (FIG. 20). The Carry Handle Force Fulcrum CHFF 740 acting on the Sweep Handle 120 is briefly transmitted to the wrist resulting in targeted pressure on a trigger point of the body. As a result, the user may experience a soothing therapeutic effect.

Newton's first law states that when the vector sum of all forces acting on an object (the net force) is zero, the object is in equilibrium. Therefore, to calculate the force into the wrist from the Carry Handle 130 in FIG. 21, we can view the forces as a static system where the forces add up to zero (Σ Ft=0). A negative Carry Handle Force CHFL 700 and positive Carry Handle Force CHFE 710 are used to calculate the force on the fulcrum and thus the wrist, Carry Handle Force CHFF 740.

$$\sum Ft = ( Carry Handle Force CHFL 700 ) + ( Carry Handle Force CHFE 710 ) + ( Carry Handle Force CHFF 740 ) = 0$$

$$\sum Ft = - Mg + 13 Mg + Carry Handle Force CHFF 740 = 0$$

$$Carry Handle Force CHFF 740 = - 12 Mg$$

Massage therapists will use a fair portion of their body weight to aid in massage techniques such as deep tissue massage. For comparison, if the Carry Handle Force CHFL 700 is (1 Kg*g), the Carry Handle Force CHFF 740=(−12 Kg*g). A massage therapist may weigh 60 Kg, therefore ⅓ of their weight translated to force is (−20 Kg*g). Although the dumping of the contents of embodiments of the Multipurpose Ergonomic Dustpan may only take a few seconds, this type of intermitent pressure point massage on the very muscles that are at labor during other modes of operation, is a therapeutic advantage.

### Wheeled Dustpan Less Distance Lifted Advantage

The Carry Handle 130 offers ergonomic and energy savings advantage since the user need not flex their wrist or arm to carry the load, when properly adjusted. However, when the user operates an embodiment Multipurpose Ergonomic Dustpan that has a ground item container equipted with wheel/s, such as the Wheeled Dustpan 88 in FIG. 15, moving the ground target to it's destination is even more advantageous. Given terrain conducive to rolling wheels, this embodiment of the Multipurpose Ergonomic Dustpan is tipped back toward the user thus engaging the wheel/s as the only point of contact between the device and the ground. The Wheeled Dustpan 88 is then pushed or pulled, similar in operation to a conventional hand truck or conventional luggage cart.

There are two advantages over conventional long handled dustpans and Multipurpose Ergonomic Dustpans that use the Carry Handle 130 when the User 300 readies the load for transport. The first is less work is required, the second is that work is even easier with the aid of a significant mechanical advantage.

When a user lifts a conventional long handled dustpan or an embodiment of the Multipurpose Ergonomic Dustpan to ready the device for carrying, the user's muscles must do work to lift the load. Work (W) is calculated by multiplying force (F) with distance (d). Here a distance of (½*A) is used as a reasonable clearance that the container is lifted off the ground before the user walks to a different location.

$$W = F * d .$$

$$F = Mg$$

$$d = ( 1 / 2 ) * A$$

$$W = \text{.5} A Mg$$

When a user tips back embodiments of the Multipurpose Ergonomic Dustpan equipted with the wheel/s on the ground item container such as illustrated in FIG. 15, work also must be performed. To calculate the work, an approximate angle of 30 degrees that the User 300 tips back the device to achieve balance, the standard load of Mg and a y-axis horizontal Wheeled Container 70 length of A is considered.

When the User 300 tips back the device 30 degrees from it's upright position while the wheel/s maintain contact with the ground, the Wheeled Container 170 is then tipped back 30 degrees with respect to the ground. Since the Ground Target 102s are normally located near the rear of the Wheeled Container 170, a center of mass is located at ⅓ the horizontal distance of A, (A/3). Because a right triangle can be anaylized with a known angle (30 degrees) and Hypotenuse, trigonometry is used to calculate the length of the opposite side which is the vertical distance the load is moved.

$$Sin ( Angle ) = ( Opposite Side ) / ( Hypotenuse )$$

$$Opposite Side = [ Sin ( Angle ) ] * ( Hypotenuse )$$

$$Angle = 30 degrees$$

$$Hypotenuse = A / 3$$

$$Opposite Side = [ Sin ( 30 degrees ) * ( A / 3 ) ]$$

$$Opposite Side = ( \text{.5} ) * ( A / 3 )$$

$$Opposite Side = \text{.17} A$$

To calculate the work User 300 must do to lift the load of Mg the distance of. 17A is used.

$$W = F * d .$$

$$F = Mg$$

$$d = ( \text{.17} ) * A$$

$$W = \text{.17} A Mg$$

Comparing the (0.5 AMG) of lifting to the (0.17 AMg) of tilting shows a 66% savings in the work required to ready embodiments of the Multipurpose Ergonomic Dustpan equipted with wheel/s on the container.

### Wheeled Dustpan Leverage Advantage

When the load in the Wheeled Container 170 is readied for transport and tipped back on the wheel/s, the user also enjoys the advantage of a class 1 lever system where the fulcrum is between the load and the effort. Here the axle of the wheel/s are the fulcrum, the Wheeled Container 170 is the load and the Dolly Handle 150 is the effort. In a class 1 lever system, the effort arm is the distance between the effort and the fulcrum. A distance of (4*A) is used for the distance between the Dolly Handle 150 and the axle of the wheels. The load arm distance is the distance between the load and the fulcrum. Again, the contents are usually pushed to the back of the Wheeled Container 170 with a horizontal y-axis length of A, therefore a center of mass distance from the fulcrum of (⅓*A) is used.

MA (Mechanical Advantage)=(Effort Arm Distance)/(Load Arm Distance)

$$Effort Arm Distance = 4 * A$$

$$Load Arm Distance = 1 / 3 * A$$

$$MA ( Mechanical Advantage ) = ( 4 * A ) / ( \text{.3} * A )$$

$$MA ( Mechanical Advantage ) = 13$$

Therefore, the User 300 ulitizes a Mechanical Advantage of 13 while lifting the contents of the Wheeled Ground Item Container 170 before transport. Because 13 times less force is needed to complete this action, the User 300's arm muscles are relieved considerably. The result is a realitively effortless action to ready the device for transport which an ergonomic advantage. Additionally, the grip can use considerably less force to support the maneuver.

### Wheeled Dustpan Dolly Knob Advantage

The grip has yet another advantage, which is the ability to utilize the Dolly Knob 152 that can stabalize the grip. When readying for transport, a light user grip is further stabalized when the pinky side of the grip comes into contact with Dolly Knob 152. The force is transferred into the bone structure of the hand. The result of the leverage advantage and knob support advantage adds up to very little effort required by the grip when readying the load for transport.

### Transporting Balance Advantage

When the User 300 transports a Multipurpose Ergonomic Dustpan equipted with the wheel/s on the ground item container by pushing it, there are three ergonomic advantages. The first is that the grip can maintain a relatively relaxed state when the device is balanced properly. The second is that upper body muscles need not flex to exert a static lift energy and the third is the well known advantage of using wheel/s attached to a device to transport desired cargo.

One reason conventional hand trucks give users the ablility to move very large loads with suprisingly little effort, up to 100's of pounds, is because the load is supported by the wheels. When the effort and load forces are balanced with respect to the force of gravity in a class 1 lever system, the sum of the effort and load forces equal the total force dispatched in reponse at the fulcrum. Therefore, the User 300's grip requires minimal effort to maintain stability.

### Transport Static Lift Energy Savings Advantage

Additionally, the grip is not supporting a load when transporting embdiments of the Multipurpose Ergonomic Dustpan equipted with the wheel/s on the ground item container. When the conventional horizontal handle or conventional vertical handle long handled dustpan is carried, the user must flex the muscles of the hand, wrist, arm and shoulder to counteract the force of gravity acting on those devices.

When some embodiments of the Multipurpose Ergonomic Dustpan are carried with the Carry Handle 130, appreciable amounts of the workload is shifted away from the smaller hand, wrist and forearm muscles though the bone structure of the forearm to larger upper arm/shoulder muscles. When a properly balanced Multipurpose Ergonomic Dustpan equipted with wheel/s on the container is transported by pushing or pulling it, the User 300 is no longer required to exert static lift energy to conteract the force of gravity. This ergonomic advantage compounds itself the longer this mode of ground item collection operation is used.

### Transport Wheel Less Friction Advantage

As as a type of simple machine, the wheel and axle work together in two different ways to make work easier by requiring less energy input. The first is that friction is reduced greatly, thus allowing for the movement of heavier loads. The forces are transmitted to the smooth surface interface between the axle and inner wheel or other designs that can include ball bearings. Less friction means less work which is an energy savings and ergonomic advantage.

### Transport Wheel Leverage Advantage

Second, the wheel and axle provide leverage, meaning they can multiply the force applied to them. This offers greater output for any given force that makes propeling loads even easier. A wheel can be analyzed as a continuous class 2 lever system where the load is located between the effort and the fulcrum. The center of the axle is the fulcrum, the radius of the axle is the load arm distance and the distance from the center of the axle to the outer edge of the wheel is the effort arm. The Mechanical Advantage of a wheel and axle is MA=(Wheel Radius)/(Axle Radius). The partnership between low friction and the mechanical advantage of leverage makes it easier to transport the wheeled dustpan.

### Transport Dolly Handle and Knob Stability Advantage

There is another advantage when transporting. When terrain or other circumstances throw off balance during transport, the abilty of both the Dolly Knob 152 and the portion of the handle stem just below the Dolly Handle 150 to retain the grip compounds the ability for not only a relaxed grip, but fosters stability that results in less mishaps that may result in unwanted spills.

Stability Advantage while Sweeping

When the user uses a sweeping device in conjunction with the Mulitpurpose Ergonomic Dustpan with forearm supports there is an advantage. As disclosed the user can slightly tilt the device while grasping the Sweep Handle 120, such as Forearm Supports Dustpan 86 of FIG. 13 when adjusting the relative angle between hand in relation to the grip and position of the Ground Item Container 172. The forearm comes into contact with the forearm support paddle to access a leverage system between the Sweep Handle 120 and the support paddle. This strategy is also applicable when moving short distances to the next ground item.

When tilted, the forearm engages a forearm paddle and the grip can also engage the Sweep Handle Knob 122. This distribution of forces results in a leverage arm that is used for stabilty and ease of movement. The lever arm system does not restrict natural adjustment of the Ground Item Container 172 around the body. For example, the angle of the User 300's forearm in relation to the z axis of the Multipurpose Ergonomic Dustpan. However, the leverage advantage is less than when grasping the Carry Handle 132 because the effort arm is shorter.

### Embedded Handle Alternate Handle Positions Sweeping Advantage

As disclosed, the Embedded Handle Apparatus 56 of FIG. 7 can be used in various embodiments of the Multipurpose Ergonomic Dustpan. When the Top Handle Grip 164 is grasped as an alternate handle to the Sweep Handle 120 during use with a sweeping device, there is an egonomic advantage. This is because the user is able to twist the hand 90 degrees either way from the grip in relation to the Sweep Handle 120. The user must also bend the arm slightly, thus changing the workload to different muscle groups. Therefore, the embodiments of the Multipurpose Ergonomic Dustpan that features an Embedded Handle Apparatus 56 offers the user three different handle/hand positions that can be used in conjunction with a sweeping device.

### Embedded Handle Alternate Handle Postions Transport Advantage

The second ergonomic advantage is when the Embedded Handle Apparatus 56 is used in embodiments of the Multipurpose Ergonomic Dustpan such as the Wheeled Dustpan 88 (FIG. 15) that feature a ground item container that incorporates wheel/s such as the Wheeled Ground Item Container 170. When the user wishes to transport the Wheeled Dustpan 88, he/she grasps the Top Handle Grip 164 after inserting the fingers from the front or back into the Paddle Grip Opening 162. Advantages are the same as previously discussed in relation to the Wheeled Ergonomic Dustpan. However, the Embedded Handle Apparatus 56 gives the user two options to choose from when transporting, thus reducing overall strain on any particular muscle group which is an ergomomic advantage.

### Back Paddle Apparatus Advantage

The Back Paddle Apparatus 58 of FIG. 8 can provide even further lifting leverage advantage when compared to the Forearm Supports Apparatus 52 with similar dimensions. This is because the postion of the Left Forearm Support Paddle 140 and the Right Forearm Support Paddle 142 are offset the z axis creating a longer effort arm. The effort arm is the distance between the fulcrum at the paddle and the grip, MA=(Effort Arm)/(Load Arm). This design is appreciable in applications with particularly large containers and/or loads.

### No Sweeping Device Needed Ergonomic Advantage

A new strategy for collecting ground items without use of a sweeping device as described with FIG. 13 provides other advantages. Because of the leverage benefits that have been discussed, the user can endure much greater stress events during use. For example, counteracting the forces of swinging a conventional long handled dustpan that comes in contact with ground items and/or the ground while maintaining stability is not recomended. This action is either something that is not possible or could cause immediate injury if successfully performed with a conventional dustpan. The previously calculated force difference on the wrist of over three times less, AMg vs. 3.25 AMg, makes it possible to scoop ground targets without use of a sweeping device. The risk or injuring the wrist is greatly reduced.

Conventional lobby brooms that are typically used in conjunction with long handled dustpans have ergonomic issues of their own. The calculation of the forces on the grip and wrist are nearly identical to the forces calculated in this document for conventional long handled dustpans. This is because the distance from the wrist to the end of the broom is comparable to the distance from the wrist to the refuse container of a long handled dustpan. When the operation of sweeping does not have to be performed, there is a clear ergonomic and energy savings advantage for the user since the arm used for sweeping rests during the manuever.

Momentum Conservation when Scooping Advantage

When the user uses the momentum of walking to provide the majority of the movement that allows for the scooping action, there is an advantage. Energy savings are availed because the user does not have to stop, then regain momentum. Newtons first law states. “An object at rest stays at rest and an object in motion stays in motion with the same speed and direction unless acted upon by an unbalanced force.” The user must use a sizable force to not only stop the mass of their body from moving, but also to regain velocity. Therfore, the activity of ground item collection is close to effortless when the activity of walking is taken for granted.

Time Savings when Scooping Advantage

There is a time savings advantage when scooping ground items while walking because stopping to sweep takes time. On a smooth surface, even items as small as cigarettes can be aquired without breaking stride. When the user is tasked with gathering 100s of items, such as cleaning parking lot, the time savings is appreciable.

Carry Handle Knob Advantage while Scooping Advantage

Additionally, the Carry Handle Knob 132 is part of the equation that allows the user an advantage with this mode of operation. That is the ability to grasp the Carry Handle 130 lightly as previously described and transfer force from the Carry Handle Knob 132. The ring shape of the thumb and forefinger absorbs the scooping force into the bone structure of the hand.

### Sweeping Device Assist Lift Advantages

As described in operation, there are a variety of situations in which the user can utilize the surface area of the head of a sweeping device in conjuntion with embodiments the Mulitpurpose Ergonomic Dustpan. That is to lay the head of the sweeping device on the contents of the Ground Item Container 172 to keep collected contents intact. Loss of contents means more work which is generally not desirable.

The additional weight from the sweeping device and stability support from the sweeping arm adds to the mass of a ground item container. The mechanical disadvantage of this operation is generally too much for an average user to endure with conventional design. The demonstrated mechanical advantages of embodiments of the Multipurpose Ergonomic Dustpan when carrying, lifting and dumping make this mode of operation possible. However, the strategy can also be used when sweeping in windy conditions.

### Sweep Handle 120 Quintuple Duty Advantage

Although the advantages listed in themselves, have been demonstrated as desirable alternatives to conventional designs, there is an overall advantage to having up to 6 hand tool designs in an easily accessable format. Transitioning from one mode to another is next to instantaineous, and in the case of dumping from a lifted state, is (FIG. 19). The five duties the single Sweep Handle 120 offers without interfering with any of the modes is in itself an advantage. One synergistic shape that is used during sweeping, then used in two leverage systems and for therapuetic advantages while carrying or dumping (FIG. 20) does not overburden the design or cause weight issues.

### Carry Handle 130 Triple Duty Advantage

Additionally, the Carry Handle serves three duties which is a similar advantage. This is because it is used when carrying (FIG. 12) and as the effort of the lever system design for lifting (FIG. 17) and dumping (FIG. 22).

### Embedded Handle Octuple Duty Egonomic and Strategic Advantages

In a similar vein of synergistic design, the Embedded Handle Apparatus 56 of FIG. 7 serves 8 duties. This is because there are two alternate ways to grasp it while sweeping, from the front or the back at a perpendicular angle to the Sweep Handle 120. This allows a user the advantage of engaging different muscle groups during the sweeping operation for ergonomic benefit. Also, there are strategic reasons while sweeping such as engaging otherwise awkward to gather ground items. The ability to rotate the Ground Item Container 90 degees either way while not rotating the wrist to those positions allows a greater range of rotational movement in the comfort zone of the user. Thus, the strategic advantages are a separate advantages.

When the Embedded Handle Apparatus 56 is utilized in embodiments of the Multipurpose Ergonomic Dustpan equipted with wheel/s, the user can also gain advantage in transport mode. Again, the option to change the orientation of the grip to access different muscle groups is an ergonomic advantage. Strategic reasons come into play also. Pushing, pulling and uneven terrain are some of the reasons a user may want to take advantage of alternate hand positions. When the options are availed for strategic reasons there are, again, separate advantages.

### Equalateral Sides Advantages

As discussed, a sweeping device can have an undesireable leverage advantage similar to conventional lobby dustpan design. This can cause strain and injury to the muscles of the hand, wrist and arm. It is ergonomically advantageous to distribute a strenous workload across a larger number of muscle groups. Thus, the symetrical design allows a user to easlily switch sides and resume identical operation as prevously described. The ergonomic advantage compounds because the likely recently strained wrist muscles, from operating the broom, can enjoy immediate therapuetic benefit.

### Offset Forearm Support Advantage

The position of the Forearm Supports 140 and 142 and subsequent Forearm Contours 146 and 148 are offset the z axis (FIG. 4). A relaxed arm and hand reveals that the palm is slightly offest toward the body from the center of the back of the forearm. When a grip is performed, the center of the grip is offset further from the palm, therefore further from the center of the back of the forearm. The position of the forearm supports and contours generally match up with the forearm's natural position (FIG. 14) in relation to the grip when grasping a handle, which is an ergonomic advantage. A slightly shorter offset than the natural position creates a good position for the Sweep Handle 120 to press into the wrist while carrying for gentle therapuetic benefit. Thus, the position of the offset is balanced between these ideas.

### Combined Ergonomic Advantages Advantage

Also, the overall combined effect of the advantages listed is an ergonomic advantage. As has been demonstrated most, if not all, duties a conventional lobby dustpan must perform require the user to compensate for a distressed mechanical disadvantage. Straining different muscles across the modes in a particular area of the body can add up to debilitating problems in the entire area. It has been demonstrated that embodiments of the Multipurpose Ergonomic Dustpan can signicantly reduce the strain on the different muscles groups used in different modes, therefore there is an overall ergonomic advantage.

### Multipurpose Advantage

A final, but vital, advantage of the disclosed embodiments of the Multipurpose Ergonomic Dustpan is to provide the user with a device that allows easy access to different ergonomic tool handles or ergonomic tool handle combinations in accordance with the duties that are typically performed. Further, the components of the multiple tool designs do not interfere with each other and in fact compliment each other. There is clear instruction on operation and benefits. The user not only has a choice for the modes, but additional choices within the some of the modes. It is easy to access the different modes and the time it takes to switch between modes is negligable. The result is a simple, useful, broadly applicable and efficient device . . . which is an advantage.

### Conclusion, Ramifications and Scope

The evolution of the dustpan lay stagnet for 1000s of years before recent history. Suprisingly, a short handle added to conventional designs, to aid in manuevering a dustpan, was invented by T. E. McNiell only 160 years ago. McNeill was also the first to recognize the problem of items falling out of the pan and introduced a bump to help hold contents in. While humans have been using brooms with extended handles in conjunction with a dustpans for milenia, it took 40 more years for Loyd P. Ray to extend McNiell's handle vertically to the natural height of hand. Now ground item collection could be done standing up.

Newer improvements include a hinged dustpan that folds to help hold contents in and a horizontal handle for a natural grip postion. The ability to adjust the horizontal grip's postion vertically is also a more recent improvement. Some catch-all tool handle designs that are claimed to work with devices such as shovels, brooms and crutches have included dustpans as a possible attachment. These designs generally claim an enclosed forearm support design with a single lower handle that offers levererage advantage while lifing. They also claim the device can also be used while sweeping.

However, the claimed dustpan attachment option is not useable for ground item collection. This is because a dustpan has a variety and unique set of duties it must perform. The duties are more numerous than, and are not congruent with, other ground tool fitments described to work in the all-encompassing tool disclosures. Hense, there are issues such as engagement, dis/engagement, time and fitment. Also, because of the fixed arm angle to the device's z axis, free adjustment around the body is restricted while sweeping. This conundrum alone renders these designs near useless since the user has to adjust with awkard body positions or extrememly frequent adjustment.

The designs also do not account for the offset position of the forearm in relation to the palm of the hand. Carrying too is inefficient, because there are two options. One is to lift the contents during this exercise, thus stressing the lifting muscles. The other is to disengage the device so it can be carried with a relaxed arm, then reengage next ground item.

The Mulitpurpose Ergonomic Dustpan's design recognizes the variety of duties a Lobby Dustpan will task. There are many leverage systems a user can access for some of the different duties. The apparatus of the systems do not interfere with the other strategic handle combinations. There is clear instruction on sweeping, carrying, transporting, lifting and dumping using the design and their advantages. To sweep, a user can grasp a properly adjusted upper horizontal handle and lift/move the device freely around the body. To carry, the user can grasp a second lower carry handle to lift the ground item container for relaxed arm transport.

To lift, the user can lightly grasp the lower handle and engage a support paddle/blade with the forearm and a grip retention knob on that handle with the edge of the grip. This creates an advantageous and easy to use leverage system. To dump after lifting, the user turns the device and the upper sweeping handle seamlessly comes into contact with the wrist to take advantage of another useful leverage system. An optional third handle and wheel/s on the ground item container make it possible to transport the device without lifting then carrying.

The multipurpose design considers body physiology, is open and symetrical. A user can easily switch sides in the interest of relieving a tired sweeping arm. The leverage system of the hand and forearm allow for scooping ground target/s without use of a supporting sweeping device. This new strategy offers energy, time and strain savings. A user can pick up items, generally on a smooth suface, via a swinging action or even without breaking stride.

Moreover, there are therapuetic benefits. Pressure Point Therapy/Massage utilizes pressure on identified points of the body that not only stimulate healing, relieve soreness and losen tight muscles . . . but is also soothing. When carrying, the upper sweep handle presses lightly into the wrist, an identified pressure point that promotes positive effects, while offering a pleasant sensation. When dumping, the pressure on the wrist is increased for a brief moment of deep tissue massage. The therapeutic effect is also and advantage when switching sides with the sweeping device.

Instruction is also given on other new advantageous stategies that can be incorporated given the disclosed advantages. Laying a sweeping device on the ground item container's contents while windy. Also doing the same when overloaded, carrying, transporting, lifting and even while dumping. Keeping contents in when unintended loss is imminent is favorable. Synergistic designs include the single sweep handle that is used in 5 different ways. The carry handle is used in three modes, and an embedded handle in the upper support blade garners at least eight ways. Different advantages for all of the modes of use also add up to an ergonomic benefit beyond current innovation.

The Mulitpurpose Ergonomic Dustpan is an advanced design because all general modes of operation have been addressed, then incorporated into a harmonious, advantagous and easy to use tool. Instruction is clear on use, and new strategies for ground item collection are disclosed. Cleaning the ground is one of the most performed and needed duties mankind conducts. The time spent on ourselves, others, pets and even nature is enormous. It is clear that this is also time spent with awkward strategies, strains and likely injury. The Multipurpose Ergonomic Dustpan's numerous ergomomic and therapeutic advancements are intended to relieve these issues.

### Disclaimer

A lesser or more handle, handle apparatus, knob, paddle or blade, forearm contour collection pan, wheel, or poles than the examples described above may be desirable for certain implementations. Therefore, the configuration of the system will vary from implementation to implementation depending upon numerous factors, such as price constraints, performance requirements, technological improvements, and/or other circumstances.

The present description presents the examples using particular terms, such as lever system, force, load, effort, fulcrum, sweep, carry, lift, dump, ground item container, therapy, handle, pole, paddle, blade, etc. These terms are used to provide consistent, clear examples, however, the present invention is not limited to any particular terminology. Similar ideas, principles, methods, apparatus, and systems can be developed using different terminology in whole, or in part. In addition, the present invention can be applied to ideas, principles, methods, apparatus, and systems that are developed around different usage models and hardware configurations.

In the present description, for the purposes of explanation, numerous specific details are set forth in order to provide a thorough understanding of the present invention. However, the present invention can be practiced without some of these specific details. In other instances, well-known structures and devices are shown in block diagram form. The specific detail can be supplied by one of average skill in the art as appropriate for any particular implementation.

Although this disclosure describes illustrative embodiments of the invention in detail, it is to be understood that the invention is not limited to the precise embodiments described. The specification and drawings are, accordingly, to be regarded in an illustrative rather than a restrictive sense. Various adaptations, modifications and alterations may be practiced within the scope of the invention defined by the appended claims.

I claim:

1. A manual dustpan comprising:
a. a handle apparatus comprising
a stem, a plurality of handles and two or more blades,
said plurality of handles being attached to said stem,
and
said two or more blades laterally attached to said stem between a narrow edge of said two or more blades and said stem,
b. an elongated pole,
c. a ground item container,
d. a lower portion of said elongated pole sufficiently secured to a section of said ground item container so as to be able to support a load force transferred from said ground item container to said elongated pole,
and
e. an upper portion of said elongated pole sufficiently secured to a portion of said handle apparatus so as to be able to support said load force transferred from said ground item container through said elongated pole to said handle apparatus,
whereby a user chooses from said plurality of handles and/or said two or more blades appropriate ergonomic, leverage, energy saving and therapeutic advantages to address various modes of dustpan operation.

2. The device of claim 1 further including
a knob securely attached to a distal end of at least one of said handles,
whereby said knob ergonomically distributes forces evenly across the edge of a user's grip, providing additional stability.

3. The device of claim 1 wherein
said two or more blades are configured to provide ergonomic comfort while allowing unrestricted lateral access to the forearm,
whereby said two or more blades provide ergonomic comfort and lateral access to the forearm.

4. The device of claim 2 wherein
said two or more blades are configured to provide ergonomic comfort while allowing unrestricted lateral access to the forearm,
whereby said two or more blades provide ergonomic comfort while providing lateral access to the forearm.

5. The device of claim 1 wherein
one or more hand sized holes are incorporated into a portion of at least one of said two or more blades,
whereby said user can insert their fingers and thumb through a hand sized hole and grasp an upper portion of said two or more blades.

6. The device of claim 1 wherein
a partially hollowed lower section of said stem is configured to receive different portions of said elongated pole,
whereby said user adjusts different lengths between said handle apparatus and said dustpan according to their preference.

7. The device of claim 6 wherein:
a. multiple sets of horizontally opposed holes are incorporated into said partially hollowed lower section,
b. one set of horizontally opposed holes are incorporated into an upper portion of said elongated pole,
and
c. further including an outward protruding button spring placed inside said elongated pole such that buttons penetrate said one set of horizontally opposed holes and one set of said multiple sets of horizontally opposed holes,
whereby an adjusted length between said handle apparatus and said ground item container can be fixed such that said elongated pole and said ground item container does not move in relation to said handle apparatus.

8. The device of claim 1 wherein
said elongated pole is converted to a telescoping pole further including:
a. a concentric tube which fits over said elongated pole,
b. a conventional telescoping tube fixing device securely affixed to a lower portion of said concentric tube,
wherein
c. an upper portion of said concetric tube is securely attached to a portion of said stem,
d. an upper portion of said elongated pole is not attached to any part,
and
e. a lower portion of said elongated pole is securely attached to the section of said ground item container,
whereby said telescoping pole allows said user to adjust a distance between said handle apparatus and said ground item container using said telescoping tube fixing device to affix said elongated pole to said concentric tube.

9. The device of claim 1 further including:
a. one or more wheel assemblies comprising one of more wheels and one or more wheel axles,
b. one or more wheel assembly housings incorporated into a structure of said ground item container,
wherein
c. said one or more wheel axles are joined to said one or more wheel assembly housings such that said one or more wheels are free from contact with said ground item container,
whereby said user chooses an appropriate handle to alter a position of said ground item container such that only said one or more wheels are in contact with a ground.

10. A manual dustpan comprising:
a. a handle apparatus comprising a stem, a plurality of handles and two or more blades, wherein
said plurality of handles are attached to said stem and said two or more blades are laterally attached to said stem between a narrow edge of said two or more blades and said stem, an elongated pole, a ground item container, wherein a lower portion of said elongated pole is sufficiently secured to a portion of said ground item container so as to be able to support a load force transferred from said ground item container to said elongated pole, and
an upper section of said elongated pole sufficiently secured to a portion of said handle apparatus so as to be able to support a load force transferred from said ground item container through said elongated pole to said handle apparatus,
b. means for receiving a hand grip when a user's arm is relaxed and said ground item container is touching a ground surface,
c. a separate means for receiving said hand grip when said user's arm is relaxed and said ground item container is freed from contact with said ground surface,
and
d. a separate means for receiving a user's forearm, providing support for lifting, while also providing unrestricted lateral access to at least one of said plurality of handles,
whereby a user chooses appropriate ergonomic, leverage, energy saving and therapeutic advantages using a combination of said plurality of handles and said two or more blades to address various modes of dustpan operation.

11. The device of claim 10 wherein
a means for a class 3 lever system comprising a load force from said ground item container, an effort force from one of said plurality of handles and a fulcrum from another handle of said plurality of handles or said one or more blades,
whereby said one of said plurality of handles supplies said effort force by the user, said another handle of said plurality of handles or said one or more blades supplies a stable fulcrum force from said user and said ground item container supplies said load force in said class 3 lever system.

12. The device of claim 10 wherein:
a. means for a class 3 lever system comprising a load force from said ground item container, an effort force supplied by one of said plurality of handles and a fulcrum supplied by one of said two or more blades,
b. means for supporting said forearm when said device is lifted,
c. means for providing wrist support and
d. means for transfering forces from means for supporting said forearm to said means for providing wrist support when said lifted device is rotated,
whereby one of said plurality of handles is supplied with said effort force by said user, said one of two or more blades supplies a stable fulcrum force and said ground item container supplies said load force in a class 3 lever system when said device is lifted and forces from said one of two or more blades are transferred to one of said plurality of handles when said lifted device is turned.

13. The device of claim 10 wherein
a means for therapy is supplied to a wrist from one handle of said plurality of handles when said one handle of said plurality of handles acts as said fulcrum in said class 3 lever system,
whereby pressure point therapy is administered to said wrist when said one handle of said plurality of handles presses into said wrist acting as said fulcrum in said class 3 lever system.

14. The device of claim 10 wherein
a hand sized hole is incorporated into an upper portion of at least one of said two or more blades, and
means for said user to grasp said at least one of said two or more blades,
whereby said user can insert fingers and thumb through said hand sized hole and grasp an upper portion of said at least one of said two or more blades.

15. The device of claim 10 further including:
a. one or more wheel assemblies comprising one of more wheels and one or more wheel axles,
b. one or more wheel assembly housings incorporated into a structure of said ground item container,
wherein
c. said one or more wheel axles are joined to said one or more wheel assembly housings and one or more wheels are assembled with said one or more wheel axles such that said one or more wheels are free from contact with said ground item container,
and
d. means for said user to transport said device on said one or more wheels,
whereby said user chooses from said plurality of handles to alter the position of the ground item container such that only one or more wheels are in contact with said ground.

16. A method for collecting, carrying, lifting and dumping ground items with a manual dustpan comprising:
grasping an upper handle with a relaxed arm while sweeping, grasping a lower handle to carry said device, lifting said device up, carrying said device with a relaxed arm, lifting and turning said device about it's x-Axis toward a user so that a dustpan breaches a target container, making contact with a forearm support with a forearm while making contact with a grip retention knob with an edge of a grip to engage a useful lever system between said grip and said contact point on said forearm, turning said device inward in relation to a body about it's z-axis, engaging said upper handle with the inside of a wrist, transfering forces at a forearm support contact point to said inside of the wrist, engaging another useful lever system between said grip and said wrist, strategically manuevering a position of an opening of the dustpan to dump, dumping the contents said dustpan into the container, turning said device outward about it's z axis, engaging said forearm with said forearm support lowering said device,
and
disengaging said lower handle,
whereby said user chooses from a plurality of handles and said forearm supports appropriate ergonomic, leverage, energy saving and therapeutic advantages using a combination of said handles and or said forearm support to address various modes of dustpan operation.

17. The method of claim 16 including a method for transporting said manual dustpan comprising:
grasping an upper handle, tilting said device about it's x axis toward said user, engaging one or more wheels with the said ground, lifting said dustpan off the ground, pushing, pulling or turning said device, tilting said device's z axis away from the z axis of said user, laying said container's bottom flat on said ground,
and
disengaging said upper handle,
whereby said user chooses the appropriate handle to alter the position of the ground item container such that only one or more wheels are in contact with the ground.

18. The method of claim 16 including a method for collecting ground items with a manual dustpan using one arm comprising:
carrying said manual dustpan while walking or moving, identifying a desirable ground item on a ground surface, lowering a collection pan of said device at a strategic moment near said ground item and scooping said item using device momentum and leverage arm assistance between the hand and forearm,
whereby said user uses one arm to collect ground items using said manual dustpan.
